(19) United States
(12) Patent Application Publication
(10) Pub. No.: US 2011/0085427 A1
(43) Pub. Date: Apr. 14, 2011

(54) FOCUS POSITION CONTROL APPARATUS, OPTICAL DISC APPARATUS USING THE SAME, AND FOCUS POSITION CONTROL METHOD

(75) Inventors: Kiyoshi MASAKI, Hyogo (JP); Kei KOBAYASHI, Osaka (JP)

(73) Assignee: PANASONIC CORPORATION, Osaka (JP)

(21) Appl. No.: 12/970,521

(22) Filed: Dec. 16, 2010

Related U.S. Application Data
(63) Continuation of application No. PCT/JP2009/002803, filed on Jun. 19, 2009.

(30) Foreign Application Priority Data
Jun. 20, 2008 (JP) 2008-162156

(51) Int. Cl. G11B 7/00

(52) U.S. Cl. 369/44.33; G9B/7

(57) ABSTRACT

A focus position control apparatus includes a memory unit configured to sequentially store a control signal for controlling a focus position of an optical beam to a desired position in synchronization with a clock signal at an associated one of clock addresses whose one round is completed as an optical disc rotates once, a memory data output unit configured to sequentially read the memory data stored in the memory unit in synchronization with the clock signal, a phase correction unit configured to correct, when the memory data output unit reads the memory data from the memory unit, a phase shift between a clock address for reading and a clock address for storing, and an adding unit configured to add an output signal of the memory data output unit to the control signal.

### CROSS-REFERENCE TO RELATED APPLICATION

This is a continuation of PCT International Application PCT/JP2009/002803 filed on Jun. 19, 2009, which claims priority to Japanese Patent Application No. 2008-162156 filed on Jun. 20, 2008. The disclosures of these applications including the specifications, the drawings, and the claims are hereby incorporated by reference in its entirety.

### BACKGROUND

The present disclosure relates to focus position control of an optical beam, such as focus control, tracking control, and the like in an optical disc apparatus for performing recording/reproduction on an optical disc.

In recent years, the recording/reproduction rate of optical disc apparatuses for performing recording/reproduction of a signal on a recordable DVD disc such as a DVD-RAM, a DVD-R, and the like, has been increased, and also, the thickness of optical disc apparatuses has been reduced. Furthermore, the wavelength of an optical source has been reduced and the numerical aperture of objective lenses has been increased, thus allowing the commercialization of large capacity optical disc apparatuses for performing recording/reproduction on a Blu-ray Disc and the like. To ensure highly reliable recording/reproduction in such a high rating, thinning, and enlarging of capacity, recording/reproduction apparatuses are required to have higher performance of focus position control of an optical beam, such as focus control, tracking control, and the like. However, it is not easy to realize control, with a sufficiently high reduction rate, to reduce high frequency disturbances caused when high-speed recording/reproduction is performed. In particular, in a thin optical disc apparatus, since a lens actuator of an optical head is small and thin, there is a restriction to thrust force to be produced. Therefore, it is very difficult to increase a control band to a high frequency. In a Blu-ray Disc apparatus having an increased density, a track pitch is small, i.e., 0.32 μm, which is 43% of that of a traditional DVD disc, and thus, high tracking accuracy is required.

A surface runout and an eccentricity are most serious problems in focus control and tracking control of an optical disc apparatus. When a disc with a large surface runout and a large eccentricity is rotated at high speed, it is not easy to stably cause transition of control and thereby allow an optical beam to follow a recording surface and a recording track of the disc with high accuracy. For example, when recording is performed on a DVD-R disc at a ×20 speed, a maximum rotation frequency is 200 Hz. In this case, when an eccentricity amount is 50 μm, a control gain of about 70 dB is necessary in order to reduce a control residual to 0.02 μm or less that allows stable recording/reproduction. To obtain the necessary control gain, the control frequency band has to be increased to at least about 15 kHz. However, because of the produced thrust force of an actuator, a high order resonance, a phase delay, and the like, it is difficult to increase the control frequency band to 10 kHz or more.

Also, there are cases in which not only a surface runout and eccentricity which vary at a rotation frequency occur, but also a local surface runout and eccentricity which vary at a higher frequency. This is caused by a local distortion which has occurred in a stamper of a master disc during the production of discs. Optical discs produced using such a stamper have a similar track distortion approximately at the same location, or a distortion along a recording surface. Such distortions cause the occurrence of a local surface runout and eccentricity, and greatly affect focus control and tracking control. In many cases, such distortions occur at each rotation in a plurality of tracks in the radial direction, a very high order disturbance relative to the rotation frequency is caused, and therefore, the distortions cannot be reduced by normal control. Accordingly, a large control residual occurs, and thus, there might be cases where recording or reproduction cannot be locally performed.

An apparatus using feed forwarding control in which information for an eccentricity and a surface runout is temporarily stored in a memory and used for focus position control has been known as correction processing to reduce influences of an eccentricity amount and a surface runout amount. The apparatus is configured so that information for an eccentricity and a surface runout is written in a memory in synchronization with the rotation frequency of a disc, and then, the written data is read from the memory and used for tracking control and focus control (see, for example, PATENT DOCUMENT 1, 2). Such an apparatus can perform normal control in a state where a surface runout and an eccentricity have been reduced using the data read from the memory, and thus, even when a disc with a large surface runout and a large eccentricity is rotated, the control residual can be reduced.

Also, a repetitive control apparatus in which a tracking error signal of a normal feedback control system is sequentially stored in a memory in synchronization with the rotation of a disc, is sequentially output with one rotation delay, and is used for tracking control has been known. The apparatus is configured so that a tracking error signal which has been stored in a memory in the previous rotation is added to a tracking error signal via a compensation means having a transfer function, which is the reciprocal of a transfer function of a feedback control system, and thus, serves as a tracking control system (see, for example, PATENT DOCUMENT 3, 4). Thus, a tracking error which could not be corrected in the previous rotation can be corrected beforehand and, and therefore, the following capability can be improved.

### CITATION LIST

### Patent Document

PATENT DOCUMENT 1: Japanese Patent Publication No. 2003-67952
PATENT DOCUMENT 2: Japanese Patent Publication No. 2005-63522
PATENT DOCUMENT 3: Japanese Patent Publication No. 2001-195760
PATENT DOCUMENT 2: Japanese Patent Publication No. 2003-91841

### SUMMARY

When data such as a tracking error signal and the like regarding an eccentricity and a surface runout is stored or read in synchronization with the rotation of a disc, there is a delay time caused by processing of a hardware or a software of the system, and therefore, a rotation phase with which data is stored in a memory might be different from a rotation phase with which data stored in the memory is to be output as an appropriate deviation amount. In such a case, data is output with an output timing shifted from a timing with which the data is to be output as an original deviation amount, and is input to a regular feedback control system. Thus, the above-described advantages might not be fully achieved, or the control residual which is to be reduced is unfavorably increased.

The influence of a timing shift due to a delay time caused when data is stored or read increases, as the rotation frequency of a disc increases and the frequency band of a control residual which is to be reduced increases. Also, the level of the influence of such a timing shift due to a delay time differs between control to reduce a control residual caused by a surface runout and an eccentricity of a rotation frequency component using data stored in a memory, and the above-described control to reduce a control residual caused by a high order frequency component such as a local surface runout and eccentricity, and the like due to a distortion of a disc, because of difference of the frequencies. Therefore, if timing is adjusted only in consideration of the rotation frequency component, the control residual of the high order frequency component such as a local surface runout and eccentricity might be unfavorably increased, as compared to normal feedback control. Thus, a timing shift due to a delay time caused when data is stored or read disturbs highly accurate focus control and tracking control, and is a major obstacle to realize high-speed recording/reproduction and high-density recording/reproduction.

Example focus position control apparatus and method allow reduction in a timing shift due to a delay time caused when data is stored or read, thus realizing highly accurate focus control or tracking control. The focus control and the tracking control are collectively referred to as the focus position control.

Specifically, a focus position control apparatus for control of a focus position of an optical beam includes: an error signal generation unit configured to generate, based on an output signal from an optical head configured to irradiate an optical disc in which a track is formed on a recording surface with an optical beam to record or reproduce data, an error signal indicating an amount of a shift of a focus position of the optical beam from a desired position; a control unit configured to generate, based on the error signal, a control signal for controlling the focus position of the optical beam to a desired position; a rotation synchronizing signal generation unit configured to generate a clock signal synchronized with a rotation of the optical disc; a memory unit configured to sequentially store, as memory data, the control signal in synchronization with the clock signal at an associated one of clock addresses whose one round is completed as the optical disc rotates once; a memory data output unit configured to sequentially read the memory data stored in the memory unit in synchronization with the clock signal; a phase correction unit configured to correct, when the memory data output unit reads the memory data from the memory unit, a phase shift between a clock address for reading and a clock address for storing; and an adding unit configured to add an output signal of the memory data output unit to the control signal. The phase correction unit corrects the phase shift both when the driving of the optical head based on the error signal is performed and when the driving is not performed, and when the driving of the optical head based on the error signal is not performed, input of the control signal to the memory unit is blocked.

Another focus position control apparatus for control of a focus position of an optical beam includes: an error signal generation unit configured to generate, based on an output signal from an optical head configured to irradiate an optical disc in which a track is formed on a recording surface with an optical beam to record or reproduce data, an error signal indicating an amount of a shift of a focus position of the optical beam from a desired position; a control unit configured to generate, based on the error signal, a control signal for controlling the focus position of the optical beam to a desired position; a rotation synchronizing signal generation unit configured to generate a clock signal synchronized with a rotation of the optical disc; first and second memory units each being configured to sequentially store, as memory data, the control signal to a desired position in synchronization with the clock signal at an associated one of clock addresses whose one round is completed as the optical disc rotates once; first and second memory data output units each being configured to sequentially read the memory data stored in an associated one of the first and second memory units in synchronization with the clock signal; a phase correction unit configured to correct, when each of the first and second memory data output units reads the memory data from an associated one of the first and second memory units, a phase shift between a clock address for reading and a clock address for storing; and an adding unit configured to add an output signal of each of the first and second memory data output units to the control signal.

Still another focus position control apparatus for control of a focus position of an optical beam includes: an error signal generation unit configured to generate, based on an output signal from an optical head configured to irradiate an optical disc in which a track is formed on a recording surface with an optical beam to record or reproduce data, an error signal indicating an amount of a shift of a focus position of the optical beam from a desired position; a control unit configured to generate, based on the error signal, a control signal for controlling the focus position of the optical beam to a desired position; a rotation synchronizing signal generation unit configured to generate a clock signal synchronized with a rotation of the optical disc; a memory unit configured to sequentially store, as memory data, the control signal in synchronization with the clock signal at an associated one of clock addresses whose one round is completed as the optical disc rotates once; first and second memory data output units each being configured to sequentially read the memory data stored in the memory unit in synchronization with the clock signal; a phase correction unit configured to correct, when each of the first and second memory data output units reads the memory data from the memory unit, a phase shift between a clock address for reading and a clock address for storing; and an adding unit configured to add an output signal of each of the first and second memory data output units to the control signal.

A focus position control method for control of a focus position of an optical beam includes: generating, based on an output signal from an optical head configured to irradiate an optical disc in which a track is formed on a recording surface with an optical beam to record or reproduce data, an error signal indicating an amount of a shift of a focus position of the optical beam from a desired position; generating, based on the error signal, a control signal for controlling the focus position of the optical beam to a desired position; generating a clock signal synchronized with a rotation of the optical disc; sequentially storing, as memory data, the control signal in synchronization with the clock signal at an associated one of clock addresses whose one round is completed as the optical disc rotates once; sequentially reading the stored memory data in synchronization with the clock signal; correcting, when the stored memory data is read, a phase shift between a clock address for reading and a clock address for storing; adding the read memory data to the control signal to control the focus position of the optical beam based on a result of the adding; and stopping storing the control signal as the memory data when the driving of the optical head based on the error signal is not performed.

### ADVANTAGES OF THE INVENTION

According to the present invention, a timing shift due to a delay time caused when data is stored or read can be adjusted according to a desired frequency band. Since a plurality of memory units are provided, correction signals corresponding to a plurality of frequencies can be generated, and each of respective output timings of the correction signals can be controlled. Thus, highly accurate, stable focus control and tracking control for high speed recording/reproduction and high density recording/reproduction can be realized.

### BRIEF DESCRIPTION OF THE DRAWINGS

FIG. 1 is a block diagram illustrating a configuration of an optical disc apparatus in which a focus position control apparatus according to a first embodiment is incorporated.

FIG. 2 is a diagram illustrating a configuration of an optical system of an optical head.

FIG. 3 is a diagram illustrating a configuration of a photodetector.

FIG. 4 is a configuration diagram of a reproduced signal processing circuit, a focus error signal generation circuit, and a tracking error signal generation circuit.

FIG. 5 is a block diagram illustrating a configuration of the focus memory processing circuit.

FIG. 6 is a flowchart illustrating the operation of the focus position control apparatus of the first embodiment.

FIG. 7 is a diagram illustrating the relationship of an FG signal, a clock signal, and a focus control signal.

FIG. 8 is a timing diagram illustrating timings for data write and data read to and from a drive memory.

FIG. 9 is a waveform diagram of a focus control signal and a focus error signal when only focus control is performed.

FIG. 10 is a waveform diagram of a focus control signal to which a memory output signal has been added, and a focus error signal.

FIG. 11 is a waveform diagram of a focus control signal to which a memory output signal has been added, and a focus error signal.

FIG. 12 is a waveform diagram of a focus control signal to which a memory output signal has been added, and a focus error signal.

FIG. 13 is a waveform diagram of a focus control signal to which a memory output signal has been added, and a focus error signal.

FIG. 14 is a waveform diagram of a focus control signal to which a memory output signal has been added, and a focus error signal.

FIG. 15 is a diagram illustrating characteristics of a bandpass filter.

FIG. 16 is a diagram illustrating the relationship between a phase correction amount and the maximum amplitude of a focus error signal.

FIG. 17 is a block diagram illustrating a configuration of an optical disc apparatus in which the focus position control apparatus of a second embodiment is incorporated.

FIG. 18 is a block diagram illustrating a configuration of a tracking memory processing circuit.

FIG. 19 is a flowchart illustrating the operation of the focus position control apparatus of the second embodiment.

FIG. 20 is a flowchart illustrating the operation of a focus position control apparatus of a third embodiment.

FIG. 21 is a block diagram illustrating a configuration of a focus memory processing circuit in a focus position control apparatus of a fourth embodiment.

FIG. 22 is a flowchart illustrating the operation of the focus position control apparatus of the fourth embodiment.

FIG. 23 a graph illustrating change in reproduction jitter relative to the phase correction amount.

FIG. 24 is a flowchart illustrating the operation of a focus position control apparatus of a fifth embodiment.

FIG. 25 is a flowchart illustrating the operation of a focus position control apparatus of a sixth embodiment.

FIG. 26 is a waveform diagram of a drive signal when tracking operation is stopped.

FIG. 27 is a waveform diagram of a track traverse signal corresponding to FIG. 26.

FIG. 28 is a waveform diagram of a drive signal when a tracking operation is stopped.

FIG. 29 is a waveform diagram of a track traverse signal corresponding to FIG. 28.

FIG. 30 is a block diagram illustrating a configuration of a focus memory processing circuit in a focus position control apparatus of a seventh embodiment.

FIG. 31 is a flowchart illustrating the operation of the focus position control apparatus of the seventh embodiment.

FIG. 32 is a diagram illustrating characteristics of the bandpass filter of FIG. 30.

FIG. 33 is a waveform diagram of a focus control signal to which only a single memory output signal is added.

FIG. 34 is a waveform diagram of a focus control signal to which only a single memory output signal is added.

FIG. 35 is a waveform diagram of a focus control signal to which two memory output signals are added, and a focus error signal.

FIG. 36 is a block diagram illustrating a configuration of a focus memory processing circuit in a focus position control apparatus according to an eighth embodiment.

FIG. 37 is a flowchart illustrating the operation of the focus position control apparatus of the eighth embodiment.

### DETAILED DESCRIPTION

### First Embodiment

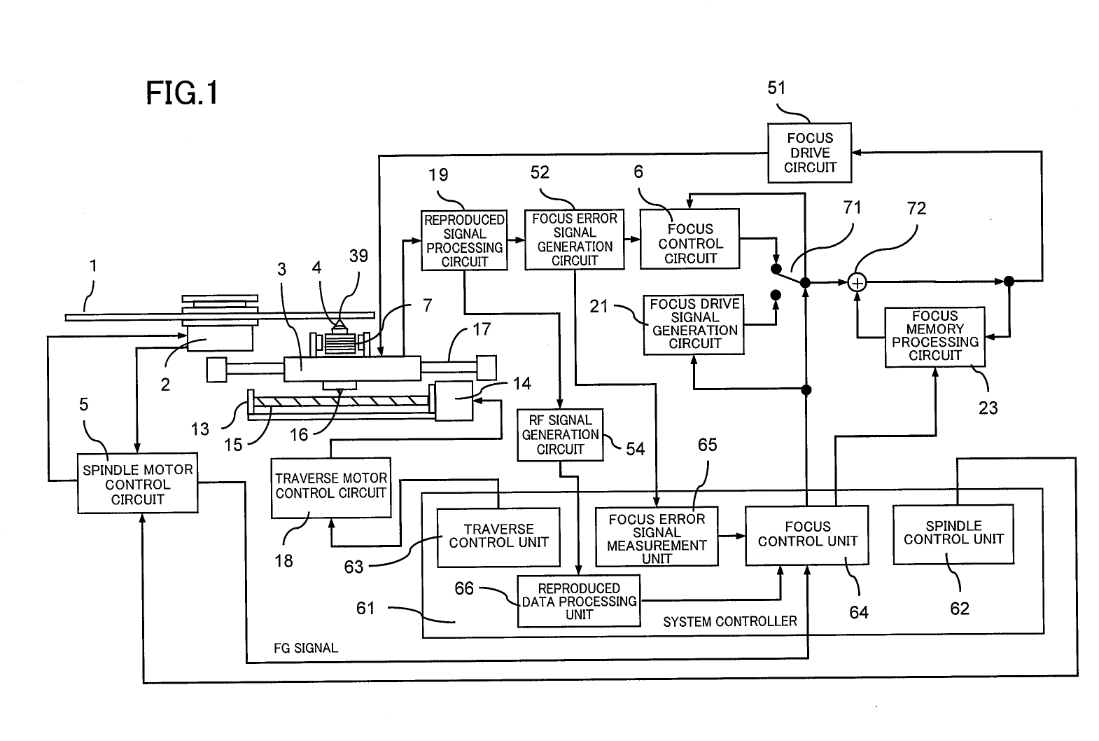

FIG. 1 is a block diagram illustrating a configuration of an optical disc apparatus in which a focus position control apparatus according to a first embodiment of the present invention is incorporated. An optical disc 1 is rotationally driven by a spindle motor 2. The rotation frequency of the spindle motor 2 is controlled by a spindle motor control circuit 5. The spindle motor control circuit 5 rotates the optical disc 1 at a rotation frequency specified by a spindle control unit 62 of a system controller 61. In this case, the spindle motor control circuit 5 generates an FG signal from a rotation synchronizing signal output from the spindle motor 2, and controls the rotation frequency of the spindle motor 2 while detecting the rotation frequency using the FG signal. An optical head 3 collects an optical beam 39 on a recording surface of the optical disc 1 to record or reproduce data. Data to be recorded is converted to a recording signal by a recording signal processing circuit (not shown) and is sent to the optical head 3. A reproduced signal read from the optical disc 1 is processed by a reproduced signal processing circuit 19, and an RF signal, which is a data reproduced signal, a focus error signal, a tracking error signal, and the like are generated.

An objective lens 4 of the optical head 3 is driven in the optical axis direction (focus direction) of the optical beam 39 by a focus actuator 7 comprised of a magnet and a focus drive coil. A focus error signal generation circuit 52 generates a focus error signal indicating a focus shift of the optical beam 39 relative to the recording surface of the optical disc 1. A focus control circuit 6 outputs a focus control signal for controlling a voltage to be applied to the focus drive coil based on the focus error signal to adjust a focus position of the optical beam 39 output from the optical head 3 on the recording surface of the optical disc 1.

An optical head moving unit 13 for moving the optical head 3 to a different radial position is comprised of a traverse motor 14, a lead screw 15, a rack 16, and a guide shaft 17. The lead screw 15 formed to serve as the rotation axis of the traverse motor 14 is engaged with the rack 16 fixed to the optical head 3. The optical head 3 is supported by the guide shaft 17 to be capable of moving straight. The optical head 3 is moved in the radial direction of the optical disc 1 by a rotation torque of the traverse motor 14 transmitted thereto via the lead screw 15 and the rack 16. The rotation of the traverse motor 14 is controlled by a traverse motor control circuit 18 according to an order of a traverse control unit 63, and the position of the optical head 3 in the radial direction is controlled.

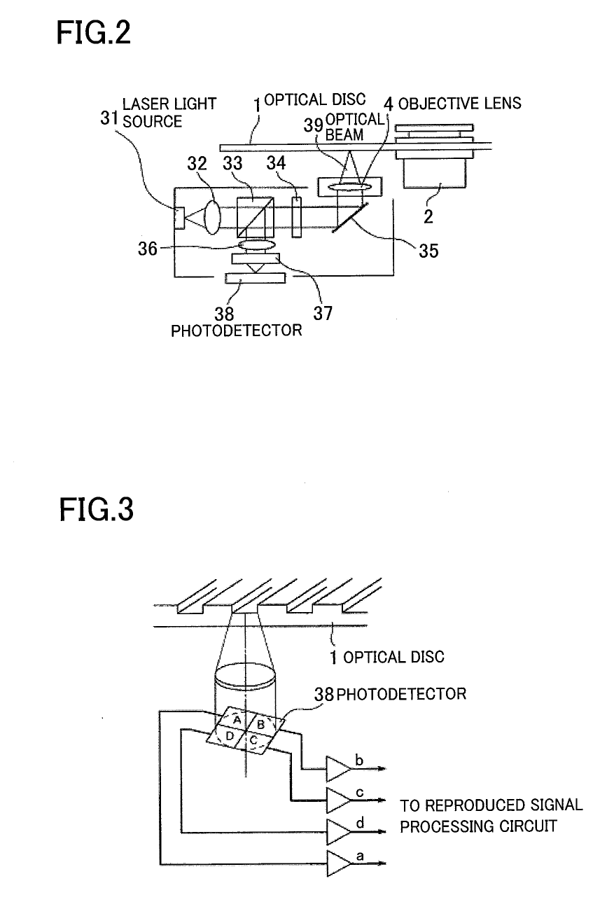

FIG. 2 is a diagram illustrating a configuration of an optical system of the optical head 3. The objective lens 4, a laser light source 31, a coupling lens 32, a polarized beam splitter 33, a quarter-wavelength plate 34, a reflection mirror 35, a detection lens 36, a cylindrical lens 37, and a photodetector 38 are attached to the optical head 3. After the optical beam 39 generated from the laser light source 31 is changed to parallel light by the lens 32, the parallel light passes through the polarized beam splitter 33 and the quarter-wavelength plate 34, is bent by the reflection mirror 35, and is focused on the recording surface of the optical disc 1 by the objective lens 4 so that the recording surface is irradiated with the light. Return light reflected on the recording surface of the optical disc 1 passes through the objective lens 4, is bent by the reflection mirror 35, passes through the quarter-wavelength plate 34 and the like, and is focused on the photodetector 38 so that the photodetector 38 is irradiated with the light.

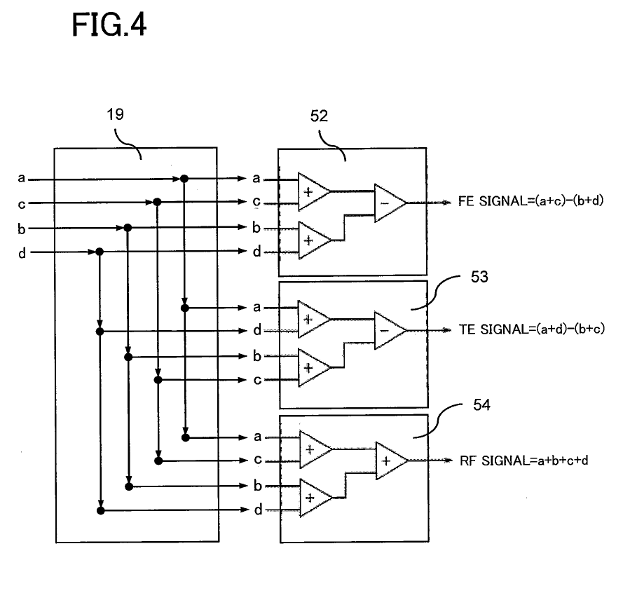

FIG. 3 is a diagram illustrating the relationship between a configuration of the photodetector 38 and reflected light from the optical disc 1. The photodetector 38 is comprised of four divided light receiving elements A, B, C, and D. Respective outputs a, b, c, and d of the light receiving element A, B, C, and D are output to the reproduced signal processing circuit 19. FIG. 4 illustrates the reproduced signal processing circuit 19, the focus error signal generation circuit 52, and an RF signal generation circuit 54. The reproduced signal processing circuit 19 outputs the outputs a, b, c, and d of the photodetector 38 to a circuit for generating an RF signal and a circuit for generating a focus error signal. The focus error signal generation circuit 52 generates a focus error (FE) signal=(a+c)−(b+d) from the outputs a, b, c, and d of the photodetector 38, and outputs the generated focus error signal to the focus control circuit 6. The RF signal generation circuit 54 generates an RF signal=(a+b+c+d) from the outputs a, b, c, and d of the photodetector 38.

Returning to FIG. 1, the focus control circuit 6 compensates for the frequency characteristic of a focus control signal to be output, such as the amplitude and phase of the focus control signal so that focus control with a desired responsive characteristic is realized to allow a stable operation. An output of the focus control circuit 6 is input to a focus drive circuit 51 via a control operation switch 71 and an adder 72. The focus actuator 7 is driven by a voltage which is output by the focus drive circuit 51 and applied to the focus drive coil.

When a focus control transitions from a state where focus control is not performed, or when a so-called focus jump for moving the focus position of the optical beam 39 from one recording layer on which recording is currently performed to another recording layer in performing recording/reproduction on a multilayer disc having a plurality of recording layers, a focus drive signal generation circuit 21 generates an acceleration drive signal or a deceleration drive signal for the focus actuator 7. The control operation switch 71 performs switching between stopping the focus control circuit 6 to block an output of the focus control circuit 6 and thereby inputting an output of the focus drive signal generation circuit 21 to the focus drive circuit 51, and causing focus control to be performed and thereby inputting an output of the focus control circuit 6 to the focus drive circuit 51. When a focus control signal is selected by the control operation switch 71, the focus control signal is input to a focus memory processing circuit 23, and an output of the focus memory processing circuit 23 is added to the focus control signal, and is input to the focus drive circuit 51.

The system controller 61 is comprised of a focus control unit 64, a focus error signal measurement unit 65, the spindle control unit 62, the traverse control unit 63, a reproduced data processing unit 66, and the like. The focus control unit 64 controls the overall focus control. The focus error signal measurement unit 65 measures the amplitude of a focus error signal. The spindle control unit 62 performs spindle motor control. The traverse control unit 63 performs traverse control. The reproduced data processing unit 66 performs processing to generate reproduced data based on an RF signal.

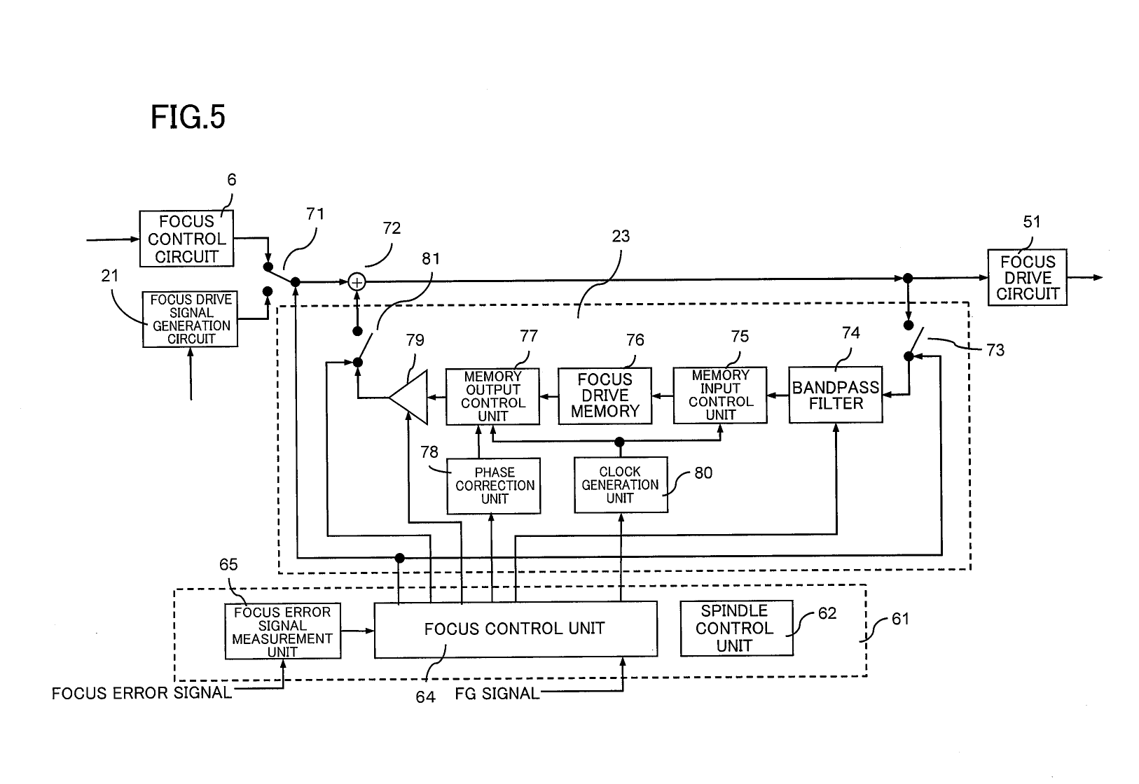

FIG. 5 illustrates a configuration of the focus memory processing circuit 23. The focus control signal is input to a bandpass filter 74 via a memory input switch 73. The bandpass filter 74 extracts a signal in a desired frequency band included in the focus control signal to generate a memory input signal, and outputs the memory input signal to a memory input control unit 75. A frequency band which the bandpass filter 74 passes is controlled to be a desired band by a filter control signal from the focus control unit 64. The memory input control unit 75 stores the memory input signal as memory data at a predetermined clock address in a focus drive memory 76 in synchronization with a clock signal. The clock signal is a rotation synchronizing signal, which is generated in a clock generation unit 80 by multiplying an FG signal input to the clock generation unit 80 via the focus control unit 64. As the optical disc 1 rotates once, one round of clock addresses is completed. A memory output control unit 77 outputs the memory data stored at a specified clock address as a memory output signal, based on an order signal from a phase correction unit 78. The memory output signal is amplified with a desired gain by an amplifier 79, and is added to the focus control signal by the adder 72 via a memory output switch 81. The gain of the amplifier 79 is controlled to be a desired gain by a gain control signal from the focus control unit 64. The focus control signal to which the memory output signal has been added is input to the focus drive circuit 51, and is converted to a voltage to drive the focus actuator 7.

The operation of the optical disc apparatus in which the focus control apparatus (focus position control apparatus) of this embodiment having the above-described configuration is incorporated will be described. First, steps before the operation of the focus control apparatus is started will be briefly described. Each step is executed based on an order from the system controller 61. First, the traverse motor control circuit 18 drives the traverse motor 14 according to an order from the system controller 61 to move the optical head 3 to a desired radial position. Next, the spindle motor control circuit 5 rotationally drives the optical disc 1 at a desired rotation frequency, which is specified by the system controller 61. In this state, the operation of the focus control apparatus is started.

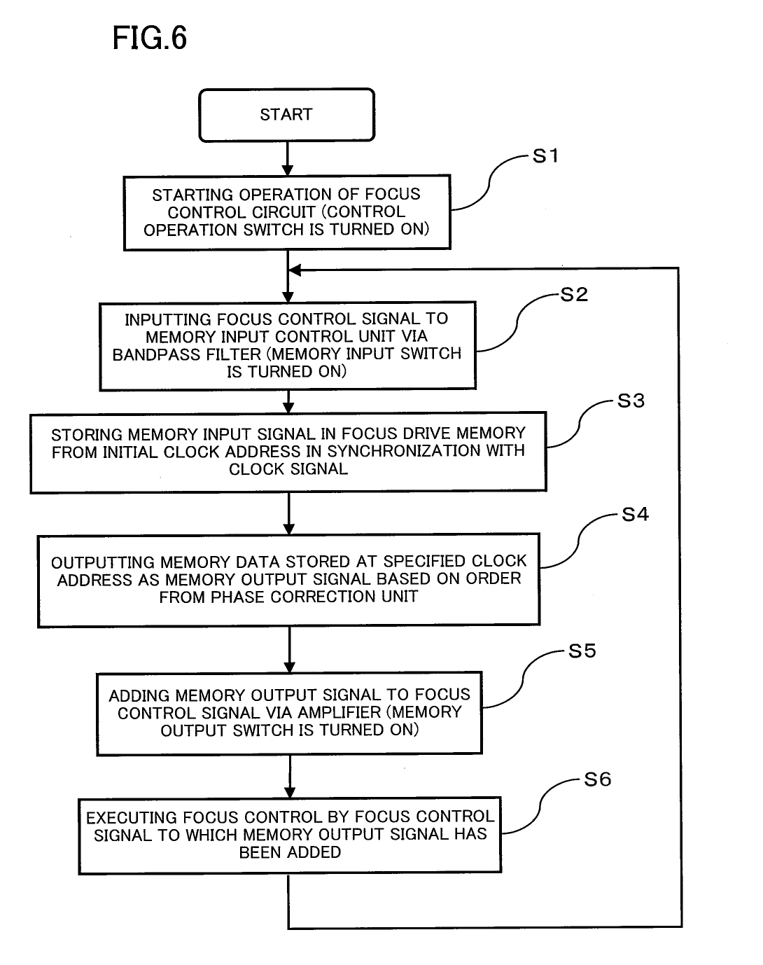

Next, details of the operation of the focus control apparatus of this embodiment will be described with reference to a flowchart of FIG. 6. First, the objective lens 4 is moved up or down by a drive signal output by the focus drive signal generation circuit 21 according to an order from the focus control unit 64. Then, when a focus error signal has become close to zero, i.e., when a focus of the optical beam 39 has become close to a disc recording surface, the focus control circuit 6 is operated according to a control operation order, and the control operation switch 71 is switched so that the focus control signal is input to the focus drive circuit 51 (S1). At the same time, the memory input switch 73 is turned on, so that the focus control signal passes through the bandpass filter 74 and is input to the memory input control unit 75 (S2). The memory input control unit 75 sequentially stores the memory input signal as memory data in the focus drive memory 76 from an initial clock address in synchronization with a clock signal, and when the optical disc 1 has rotated once since a start of storing memory input signals, storing of the memory input signals is repeated from the initial clock address (S3). When the optical disc 1 has rotated once or more since the start of storing the memory input signals, the memory output control unit 77 starts outputting, as a memory output signal, memory data stored at a specified clock address in synchronization with a clock, based on an order signal from the phase correction unit 78 (S4). At the same time, the memory output switch 81 is turned on, so that the memory output signal is added to the focus control signal via the amplifier 79 (S5), and focus control is executed by the focus control signal to which the memory output signal has been added (S6).

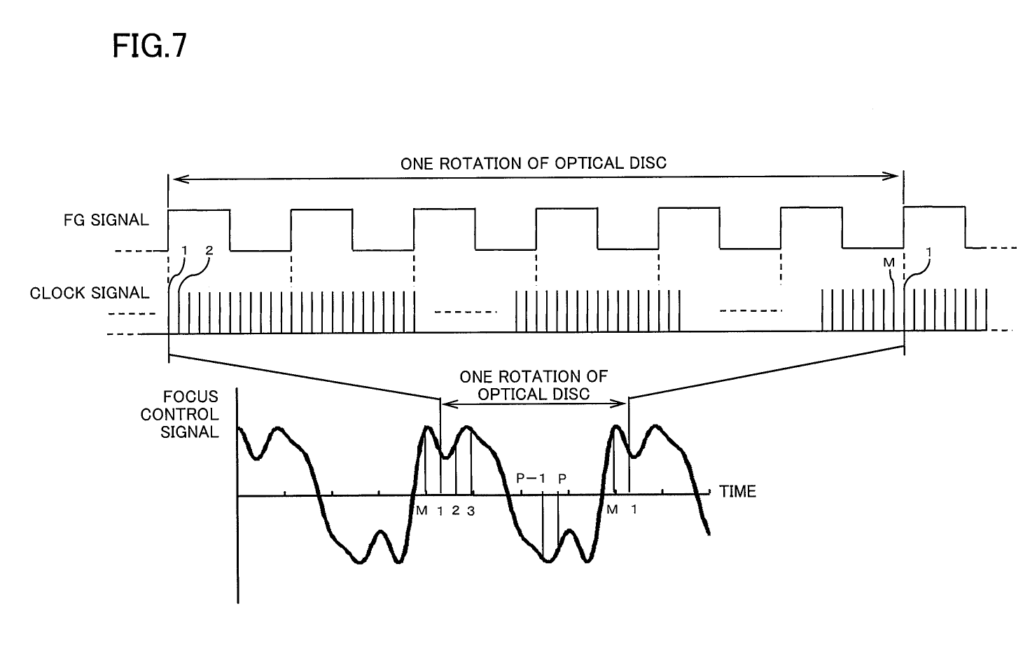

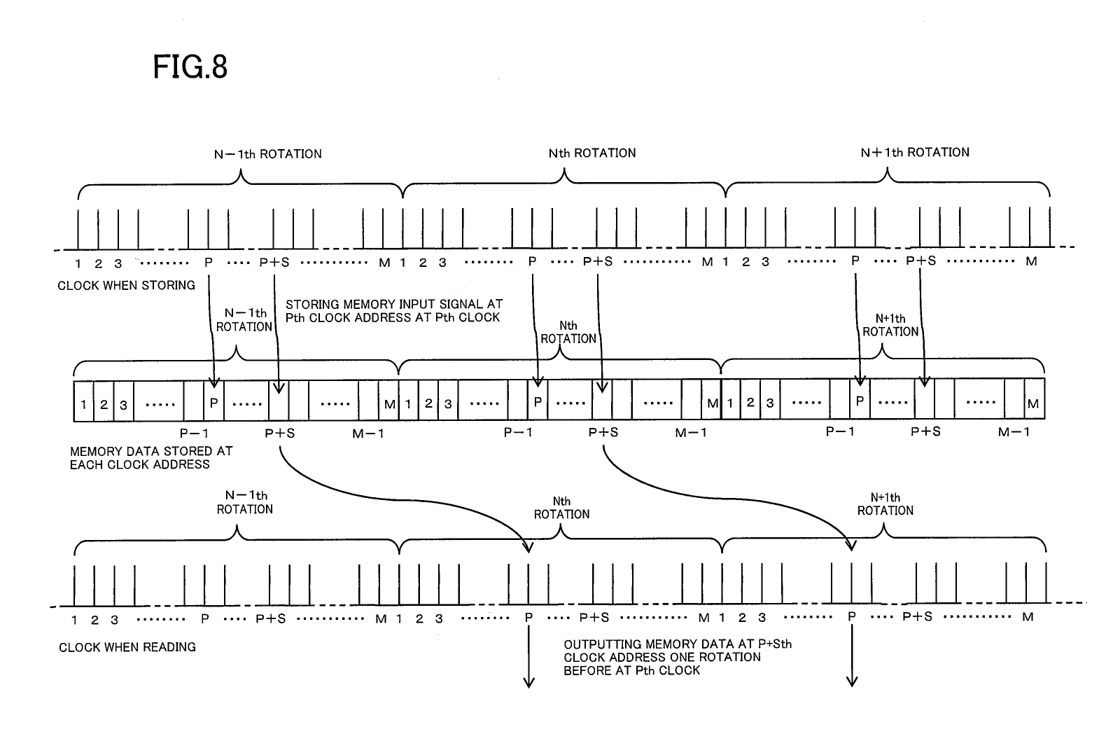

The operation after the focus control signal which has passed through the bandpass filter 74 is input to the memory input control unit 75 (S2) until memory data is output as a memory output signal (S4) will be described further in detail. FIG. 7 illustrates an FG signal, a clock signal, and a focus control signal, i.e., a memory input signal to be stored at each clock address in the focus drive memory 76. The clock signal is output in synchronization with the FG signal with a timing obtained by dividing one rotation of the optical disc 1 into M. FIG. 8 illustrates a clock signal indicating a timing with which data is stored in the focus drive memory 76, memory data stored at each clock address in the focus drive memory 76, a clock signal indicating a timing with which the memory data is read from the focus drive memory 76, and memory data to be read in synchronization with a clock signal. The memory input signal is stored as Pth memory data at a Pth clock address in synchronization with a Pth clock. When memory data is read, memory data stored at a (P+S)th clock address in the previous rotation of the optical disc 1 is output in synchronization with the Pth clock. That is, memory data is output such that a phase is advanced by S clocks from a clock in the previous rotation when memory data has been stored. The number of clocks by which the phase is advanced is specified by the phase correction unit 78.

As described above, by reading memory data with a phase advanced by S clocks, a processing time of the memory input control unit 75, a processing time for writing to the focus drive memory 76, and a delay of a memory output signal from a focus control signal caused by a phase delay due to the frequency characteristic of the bandpass filter 74 can be corrected. If the delay is not corrected, a memory output signal is added as an original deviation amount to a focus control signal with a timing shifted from a timing with which the memory output signal is to be output. Thus, an unnecessary disturbance to normal feedback control performed in the focus control circuit 6 occurs, and a control residual which is to be reduced is unfavorably increased. Therefore, by performing the above-described correction of such a delay, so-called repetitive control effect, i.e., a control residual which cannot be reduced by the normal feedback control by the focus control circuit 6 can be also reduced.

Next, adjustment of a delay correction amount, which is another feature of the present invention will be described. The adverse effect of the delay increases, as the rotation frequency of a disc increases and a frequency band of a control residual which is to be reduced increases. Also, an optimal delay correction amount might vary due to the frequency of a control residual which cannot be reduced by the normal feedback control by the focus control circuit 6, i.e., the frequency of a control residual which is to be reduced. When a delay time of a memory output signal from a focus control signal is determined only by a process time of a hardware or a software, the delay time is constant. However, as the rotation frequency increases, the number of clocks which are to be corrected increases. Also, even with the same rotation frequency, as the frequency of a control residual which is to be reduced increases, the number of clocks existing in a variation cycle of the control residual reduces, and therefore, the level of influence of one clock delay increases. Moreover, if a component, such as the bandpass filter 74 and the like, which has a frequency characteristic is provided, a delay due to the phase characteristic thereof is added. In such a case, a delay time varies due to the frequency of a control residual which is to be reduced. Therefore, optimal adjustment of a delay correction amount has to be appropriately performed so that a greatest advantage of repetitive control using a memory can be achieved.

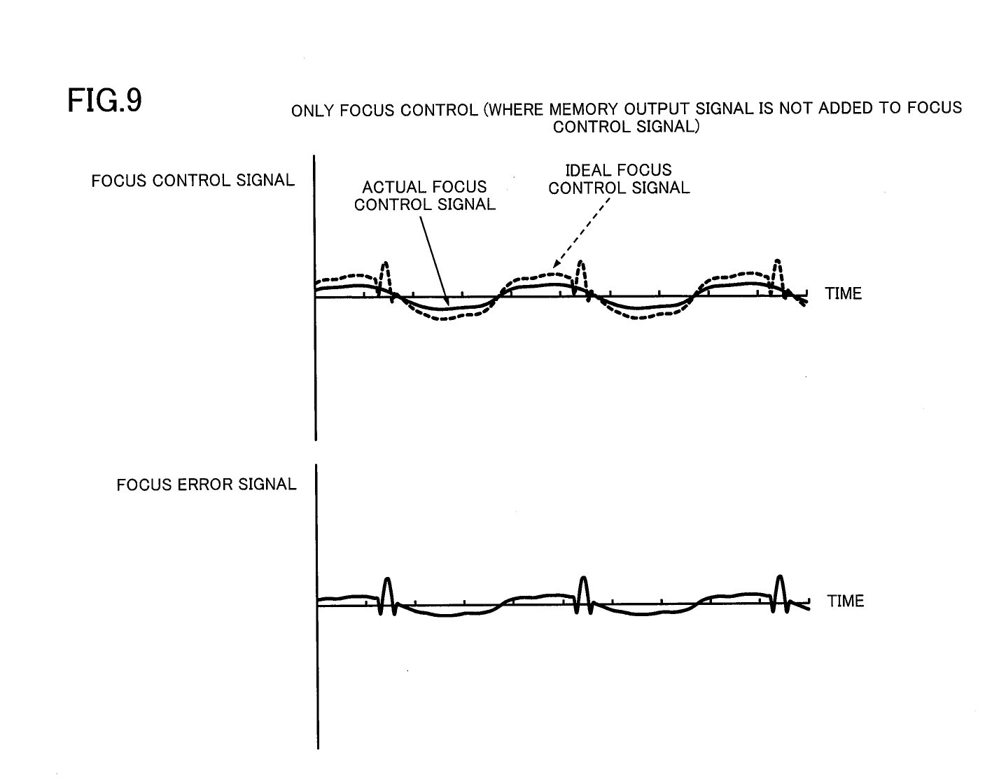

FIG. 9 illustrates change in a focus control signal and a focus error signal with time, when a memory output signal is not added to the focus control signal (memory output switch is off). In this case, the rotation frequency of the optical disc 1 is about 200 Hz, and a gain crossover is at about 6 kHz. Also, in this case, a surface runout of the rotation frequency, its high order component, and a local surface runout of a frequency which is about 10 times the rotation frequency due to a distortion of the optical disc 1 exist in the optical disc 1. The dashed line represents an ideal focus control signal with which a control residual can be reduced to a sufficiently small value to perform recording/reproduction. As shown in FIG. 9, the normal feedback control cannot follow a surface runout component of the rotation frequency, and a high order local surface runout at all.

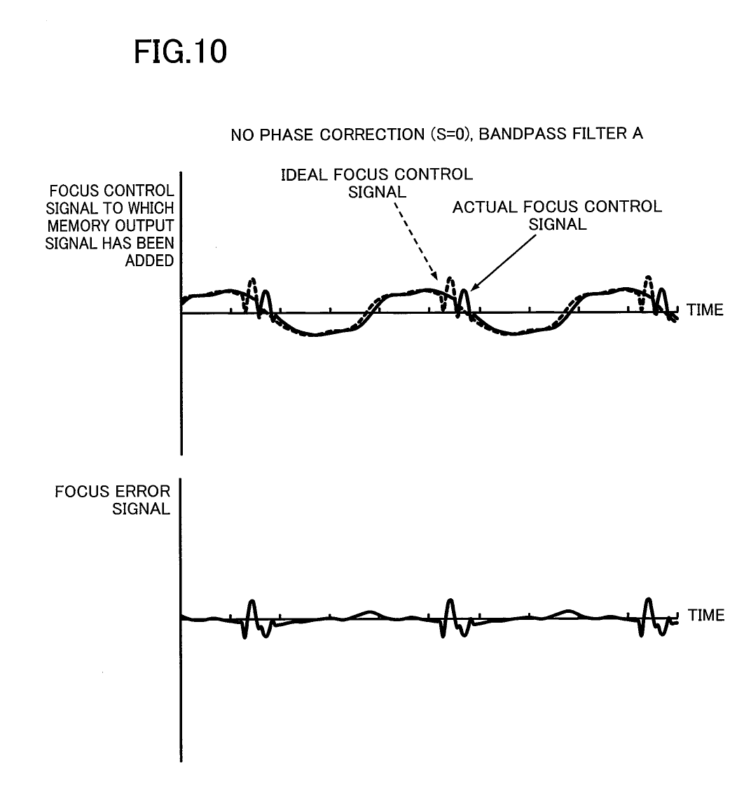

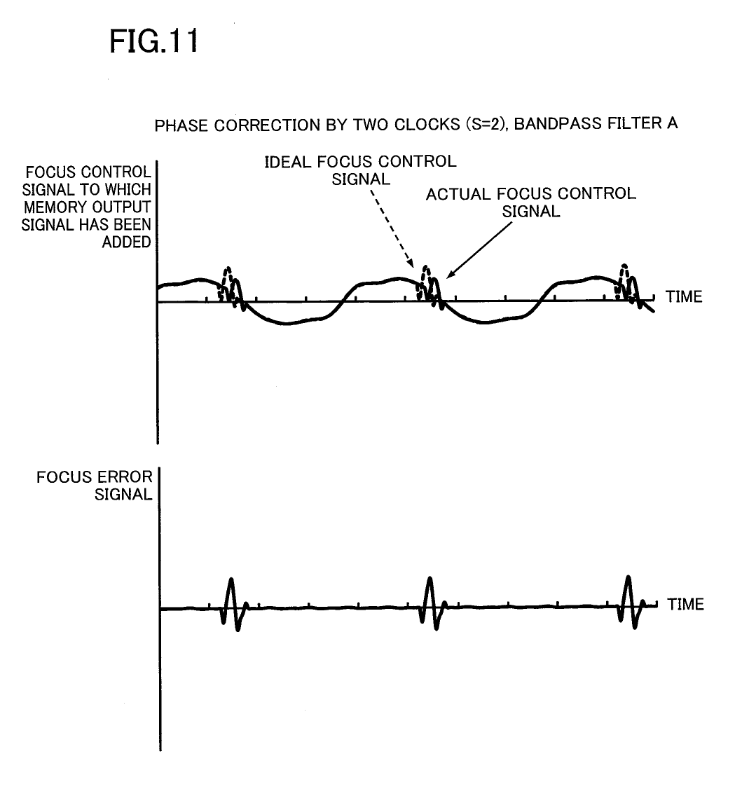

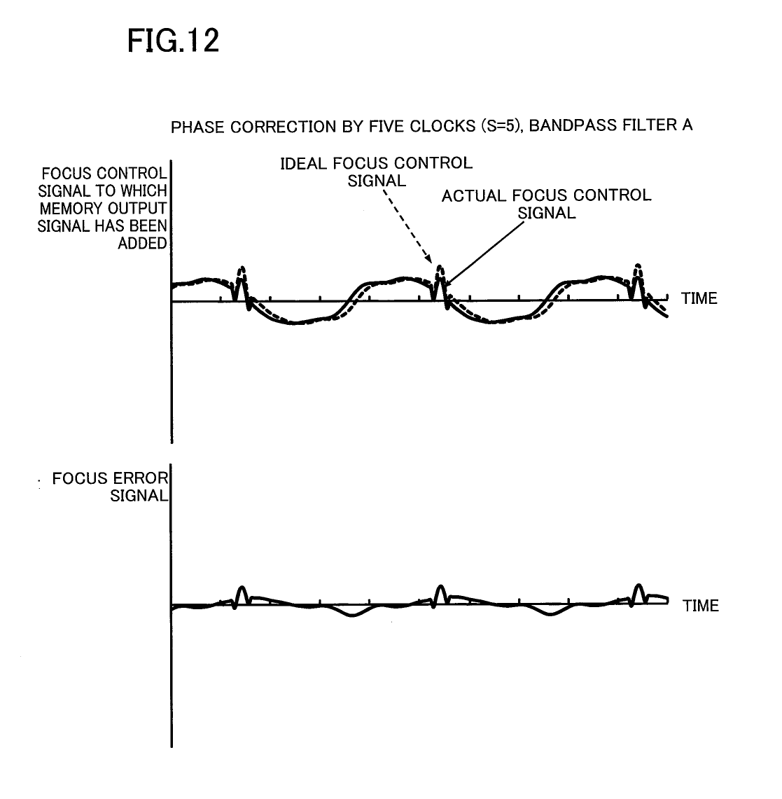

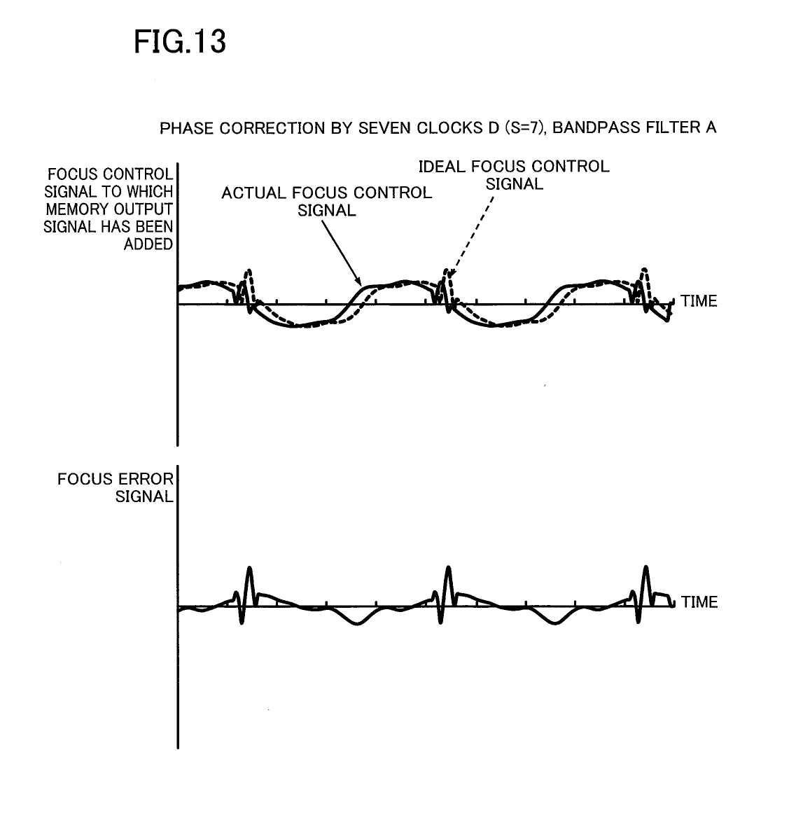

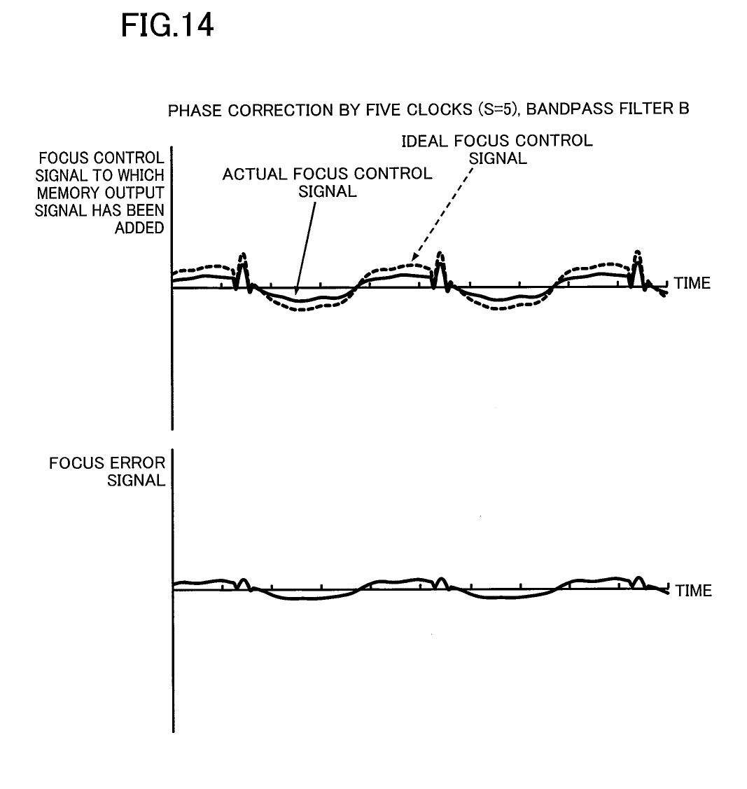

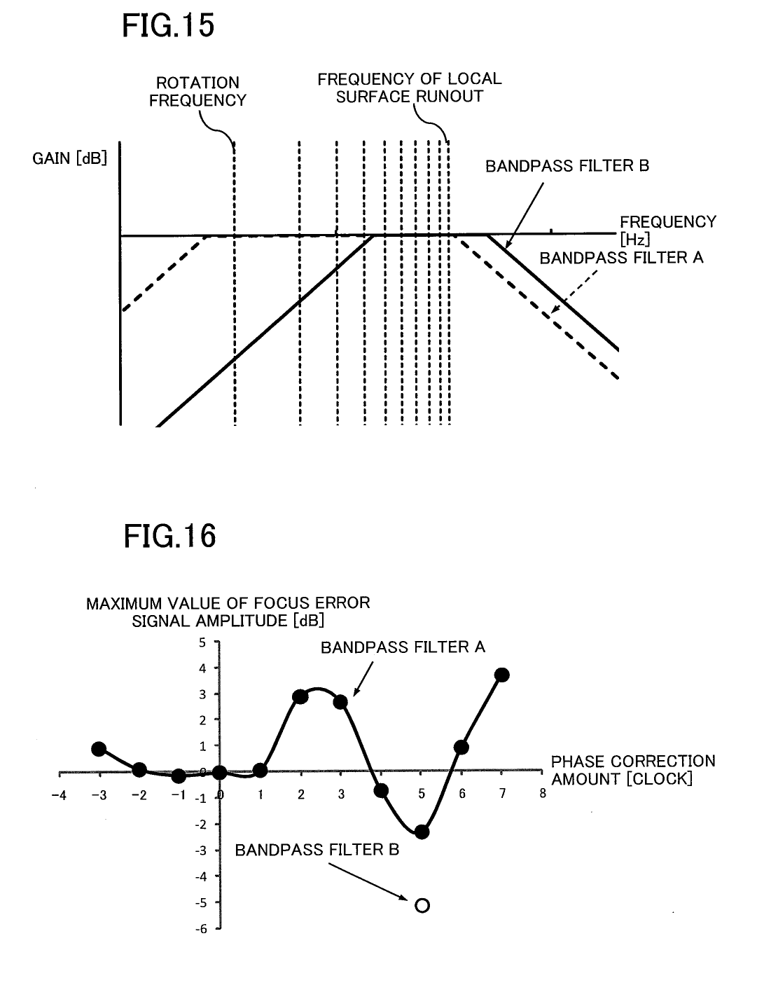

Each of FIGS. 10-14 illustrates change in a focus control signal and a focus error signal with time, when a memory output signal is added (memory output switch is on) to the focus control signal under the same condition as that described above. FIG. 15 illustrates characteristics of the bandpass filter 74. In FIGS. 10-13, the bandpass filter 74 passes a frequency band ranging from the rotation frequency component to a frequency component of a local surface runout. FIG. 10 illustrates a case where the phase correction amount S specified by the phase correction unit 78 is zero. As can be seen from FIG. 10, the rotation frequency component is reduced more greatly, as compared to the case shown in FIG. 9 where only normal focus control is performed. However, for the high order local surface runout component, a large phase delay occurs to the focus control signal, and the high order local surface runout component is degraded, as compared to the normal focus control. This is because of a processing time of the memory input control unit 75, a processing time for writing to the focus drive memory 76, and a delay of a memory output signal from a focus control signal caused by a phase delay due to the frequency characteristic of the bandpass filter 74 and the like. It can be seen form FIG. 10 that the higher frequency component is affected more greatly. FIG. 11 illustrates a case where the phase correction amount S is set to be 2. In this case, the low frequency component including the rotation frequency component is totally reduced, but the high order component is further degraded. FIG. 12 illustrates a case where the phase correction amount S is set to be 5. In this case, the phase of the low frequency component in the focus control signal is advanced too much, and thus, there is a control residual of the rotation frequency component. However, a high order control residual is reduced to be small. FIG. 13 illustrates a case where the phase correction amount S is set to be 7. In this case, the phase of the focus control signal is advanced too much, and a control residual is totally increased. In FIG. 14, similar to FIG. 12, the phase correction amount S is set to be 5. However, the bandpass filter 74 has a different characteristic from that in the case shown in FIG. 12. That is, the bandpass filter 74 blocks low frequency components such as the rotation frequency component, and passes only the high frequency components including the local surface runout component. Thus, low frequency components are not stored in the focus drive memory 76, so that low frequency components in the memory output signal, i.e., the focus control signal, whose phase is advanced too much no longer exist. Therefore, increase in control residual of the rotation frequency component can be prevented.

FIG. 16 is a diagram illustrating the relationship between the phase correction amount S and a control residual, and illustrates change in maximum value of the amplitude of the focus error signal when the phase correction amount S is changed. The ordinate indicates the ratio of an amplitude of the focus error signal to the maximum amplitude of the focus error signal where only normal focus control is performed as a reference in decibel. As can be seen from FIG. 16, under the conditions of FIGS. 9-13, the control residual can be reduced to be minimal when the phase correction amount S is set to be 5. Also, FIG. 16 shows that it is optimal to set the phase correction amount S to be 2, when low frequency components such as the rotation frequency component and the like have to be reduced. Furthermore, as in FIG. 14, when the characteristic of the bandpass filter 74 is optimized, the control residual can be reduced further, as compared to the case of FIG. 12.

As described above, the frequency of a phase delay and the level of the frequency vary according to the amount of a surface runout of the optical disc 1 on which recording/reproduction is performed, whether or not a high order local surface runout exists, the magnitude of the high order local surface runout, a processing time of the memory input control unit 75, a processing time for writing to the focus drive memory 76, and the frequency characteristic of the bandpass filter 74 or the like. However, the focus control apparatus of this embodiment allows correction of a phase shift between a clock position when data is read and a clock position when data is written to the focus drive memory 76. Thus, the control residual can be reduced to be small by setting an optimal phase correction amount S according to conditions of such a case. Furthermore, since the frequency band of a memory input signal to be input to the focus drive memory 76 can be restricted by the bandpass filter 74, it is possible to prevent a phase from being advanced too much by phase correction in an unnecessary band. Thus, the control residual can be reduced to be minimal at any time in any case.

### Second Embodiment

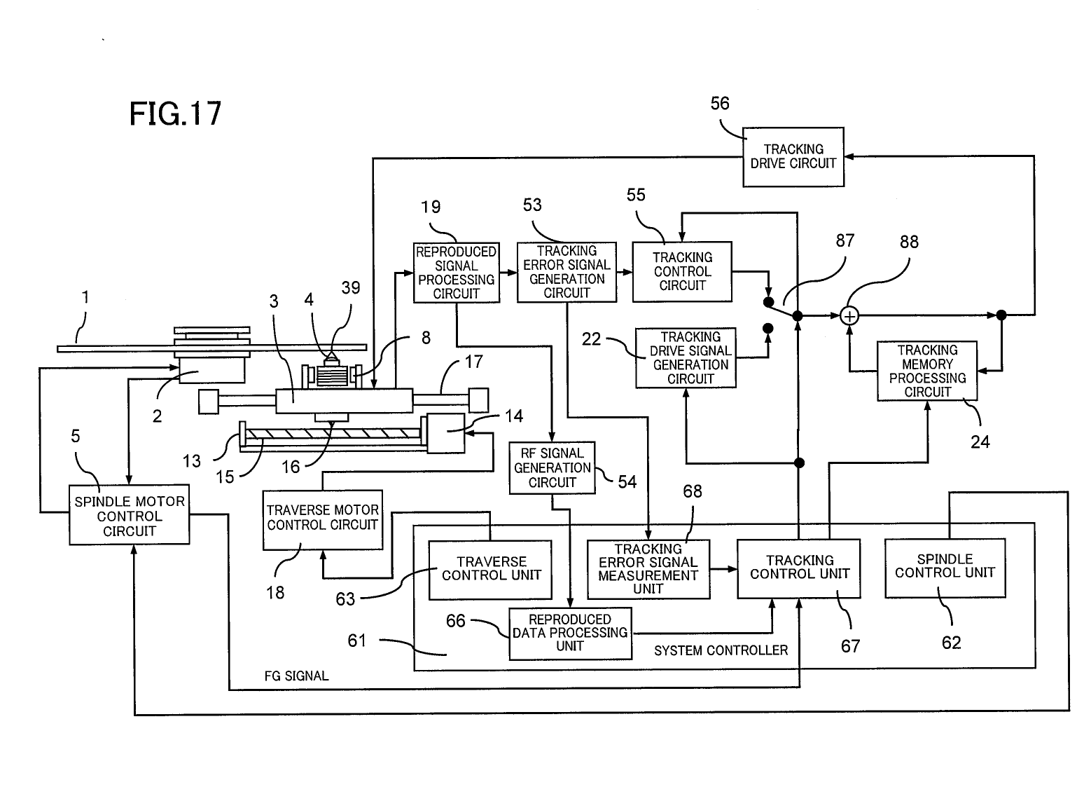

FIG. 17 illustrates a configuration of an optical disc apparatus in which a focus position control apparatus of a second embodiment is incorporated. In the focus position control apparatus of this embodiment, the focus control in the focus position control apparatus of the first embodiment is replaced with tracking control. Only differences of the second embodiment from the first embodiment will be hereinafter described.

An objective lens 4 is driven in the radial direction (tracking direction) of an optical disc 1 by a tracking actuator 8 comprised of a magnet and a tracking drive coil. A tracking error signal generation circuit 53 generates a tracking error signal indicating a shift of a focus position of an optical beam 39 from a track formed in a recording surface. A tracking control circuit 55 outputs a tracking control signal for causing the optical beam 39 output from an optical head 3 to follow the track formed in the recording surface. A tracking drive circuit 56 controls a voltage to be applied to the tracking drive coil based on the tracking control signal. FIG. 4 illustrates the tracking error signal generation circuit 53. The tracking error signal generation circuit 53 generates a tracking error (TE) signal=(a+d)−(b+c) from outputs a, b, c, and d of a photodetector 38 to output the TE signal to the tracking control circuit 55.

Returning to FIG. 17, the tracking control circuit 55 compensates for the frequency characteristic of the tracking control signal to be output, such as the amplitude and phase of the tracking control signal so that tracking control with a desired responsive characteristic is realized to allow a stable operation. An output of the tracking control circuit 55 is input to the tracking drive circuit 56 via a control operation switch 87 and an adder 88. The tracking actuator 8 is driven by a voltage output by the tracking drive circuit 56 and applied to the tracking drive coil.

When a tracking control transitions from a state where tracking control is not performed, i.e., for example, when the optical head 3 has moved to a different radial position and the like, or when a so-called track jump for moving the focus position of the optical beam 39 from one track to another, a tracking drive signal generation circuit 22 generates an acceleration drive signal or a deceleration drive signal for the tracking actuator 8. The control operation switch 87 performs switching between stopping the tracking control circuit 55 to block an output of the tracking control circuit 55 and thereby inputting an output of the tracking drive signal generation circuit 22 to the tracking drive circuit 56, and causing tracking control to be performed and thereby inputting an output of the tracking control circuit 55 to the tracking drive circuit 56. When the tracking control signal is selected by the control operation switch 87, the tracking control signal is input to a tracking memory processing circuit 24, and an output of the tracking memory processing circuit 24 is added to the tracking control signal by the adder 88 and then is input to the tracking drive circuit 56.

The system controller 61 is comprised of a tracking control unit 67, a tracking error signal measurement unit 68, a spindle control unit 62, a traverse control unit 63, a reproduced data processing unit 66, and the like. The tracking control unit 67 performs the overall tracking control. The tracking error signal measurement unit 68 measures the amplitude of a tracking error signal.

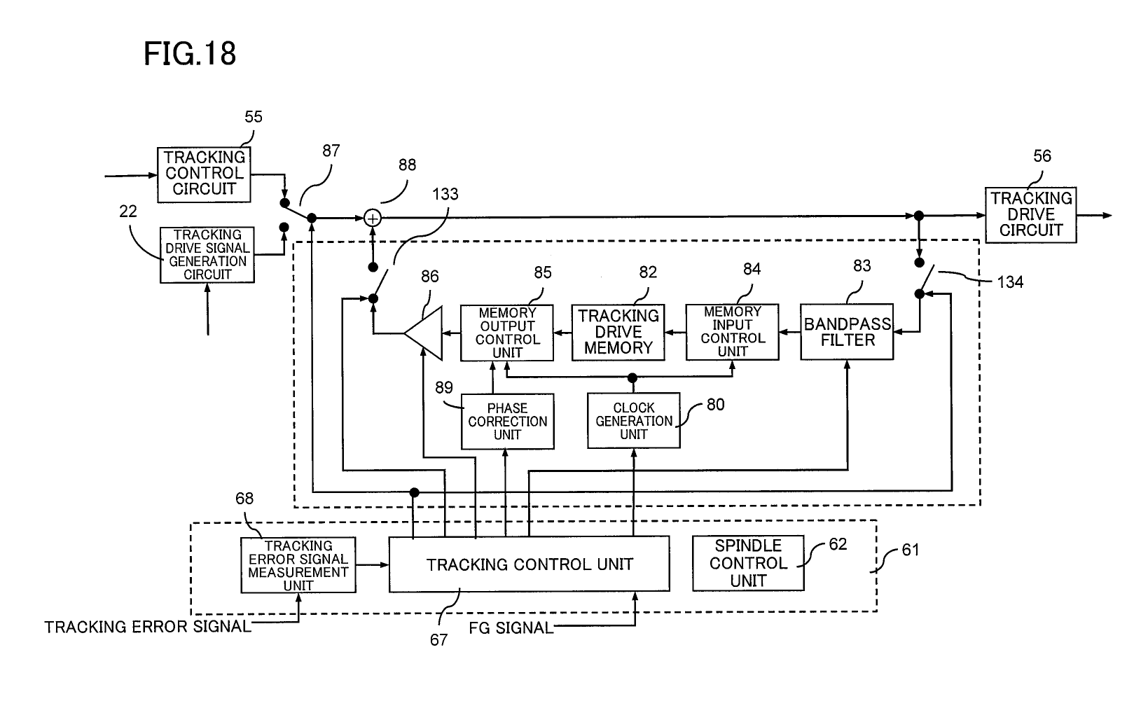

FIG. 18 illustrates a configuration of the tracking memory processing circuit 24. A tracking control signal is input to a bandpass filter 83 via a memory input switch 134. The bandpass filter 83 extracts a signal in a desired frequency band included in the tracking control signal to generate a memory input signal, and outputs the memory input signal to a memory input control unit 84. A frequency band which the bandpass filter 83 passes is controlled to be a desired band by a filter control signal from the tracking control unit 67. The memory input control unit 84 stores the memory input signal as memory data at a predetermined clock address in a tracking drive memory 82 in synchronization with a clock signal. The clock signal is a rotation synchronizing signal, which is generated in a clock generation unit 80 by multiplying an FG signal input to the clock generation unit 80 via the tracking control unit 67. As the optical disc 1 rotates once, one round of clock addresses is completed. A memory output control unit 85 outputs memory data stored at a specified clock address as a memory output signal, based on an order signal from a phase correction unit 89. The memory output signal is amplified with a desired gain by an amplifier 86, and is added to the tracking control signal by the adder 88 via a memory output switch 133. The gain of the amplifier 86 is controlled to be a desired gain by a gain control signal from the tracking control unit 67. The tracking control signal to which the memory output signal has been added is input to the tracking drive circuit 56, and is converted to a voltage to drive the tracking actuator 8.

The operation of the optical disc apparatus in which the tracking control apparatus (focus position control apparatus) of this embodiment having the above-described configuration is incorporated will be described. First, steps before the operation of the tracking control apparatus is started will be briefly described. Each step is executed based on an order from the system controller 61. First, a traverse motor control circuit 18 drives a traverse motor 14 according to an order from the system controller 61 to move the optical head 3 to a desired radial position. Next, a spindle motor control circuit 5 rotationally drives the optical disc 1 at a desired rotation frequency, which is specified by the system controller 61. Then, the operation of the focus control apparatus is started, and the operation of the tracking control apparatus is started in a state where focus control is performed.

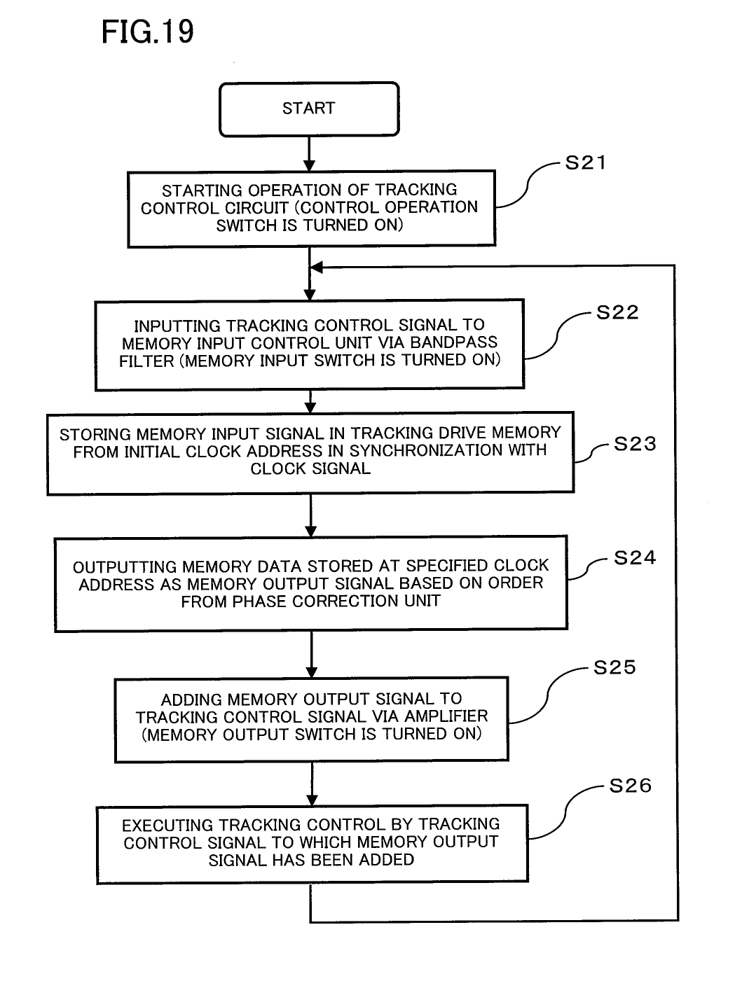

Next, details of the operation of the tracking control apparatus of this embodiment will be described with reference to a flowchart of FIG. 19. First, when a track traverse frequency due to an eccentricity of a track has become relatively low, the tracking control circuit 55 is operated by a control operation order from the tracking control unit 67, and the control operation switch 87 is switched, so that a tracking control signal is input to the tracking drive circuit 56 (S21). At the same time, each of the memory input switches 134 and 133 is turned on, so that the tracking control signal passes through the bandpass filter 83 and is input to the memory input control unit 84 (S22). The memory input control unit 84 sequentially stores the memory input signal as memory data in the tracking drive memory 82 from an initial clock address in synchronization with a clock signal, and when the optical disc 1 has rotated once since a start of storing memory input signals, storing of the memory input signals is repeated from the initial clock address (S23). When the optical disc 1 has rotated once or more since the start of storing the memory input signals, the memory output control unit 85 starts outputting, as a memory output signal, memory data stored at a specified clock address in synchronization with a clock, based on an order signal from the phase correction unit 89 (S24). At the same time, the memory output switch 133 is turned on, so that the memory output signal is added to the tracking control signal via the amplifier 86 (S25), and tracking control is executed by the tracking control signal to which the memory output signal has been added (S26).

Note that details of the operation after the tracking control signal which has passed through the bandpass filter 83 is input to the memory input control unit 84 (S22) until memory data is output as a memory output signal (S24) are similar to those of the first embodiment. Also, the surface runout of a rotation frequency component in the focus control, which has been described in the first embodiment, corresponds to an eccentricity of a track in the tracking control of this embodiment. The high order local surface runout in the focus control of the first embodiment corresponds to a high order local eccentricity of a track in the tracking control of this embodiment.

As described above, similar to focus control, the frequency of a phase delay and its level vary in tracking control according to the amount of an eccentricity of the optical disc 1 on which recording/reproduction is performed, whether or not a high order local eccentricity exists, the magnitude of the high order local eccentricity, a processing time of the memory input control unit 84, a processing time for writing to the tracking drive memory 82, and the frequency characteristic of the bandpass filter 83 and the like. However, the tracking control apparatus of this embodiment allows correction of a phase shift between a clock position when data is read and a clock position when data is written to the tracking drive memory 82. Thus, the control residual can be reduced to be small by setting an optimal phase correction amount S according to conditions of such a case. Furthermore, the frequency band of a memory input signal to be input to the tracking drive memory 82 can be restricted by the bandpass filter 83, and it is possible to prevent a phase from being advanced too much by phase correction in an unnecessary band. Thus, a control residual can be reduced to be minimal at any time in any case.

### Third Embodiment

A focus position control apparatus according to a third embodiment of the present invention is configured so that a delay correction amount which causes the maximum amplitude of an error signal to be the smallest is obtained as an optimal phase correction amount S. A case where the focus position control apparatus of this embodiment is a focus control apparatus will be described hereinafter as an example. The focus position control apparatus of this embodiment and an optical disc apparatus in which the focus position control apparatus is incorporated have similar configurations to those of the first embodiment (see FIGS. 1 and 5). A focus error signal measurement unit 65 measures the amplitude of a focus error signal generated in a focus error signal generation circuit 52. The amplitude of the focus error is measured while a clock number S as a phase correction amount is changed, and the clock number S with which the amplitude is the smallest is determined.

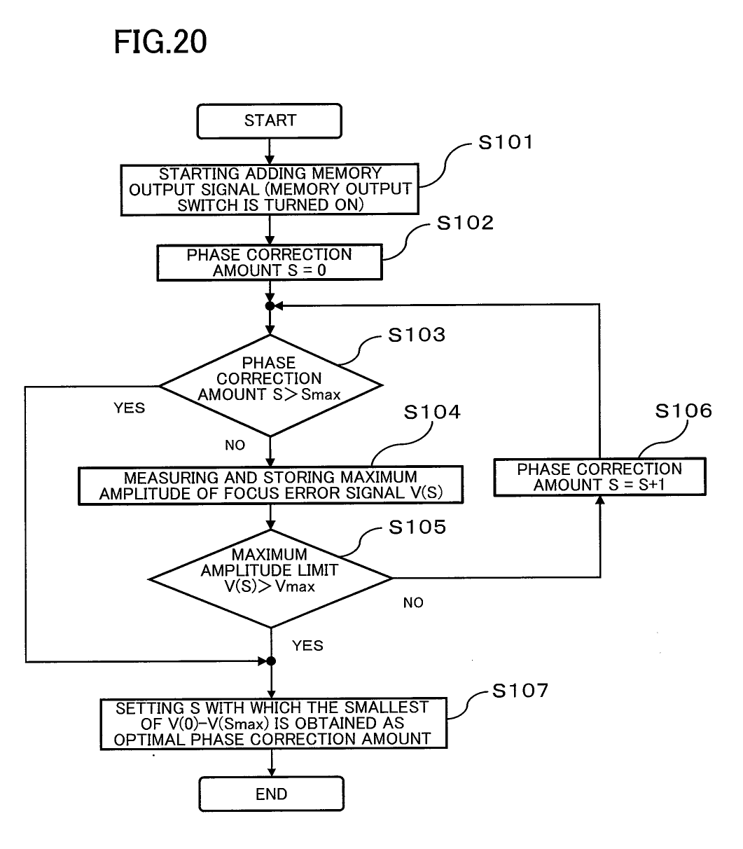

The operation of the focus position control apparatus of this embodiment will be described with referent to a flowchart of FIG. 20. First, storing and reading of memory data is performed to a focus drive memory 76, a memory output signal is added to a focus control signal, and focus control is performed using the focus control signal to which the memory output signal has been added. In this state, i.e., a state where a memory output switch 81 is in an on state, the operation is started (S101). A phase correction unit 78 sets the phase correction amount S=0 for a memory output control unit 77 according to an order from the focus control unit 64 (S102). In a state where the memory output control unit 77 takes out memory data and outputs the taken data with the phase correction amount S=0, the focus error signal measurement unit 65 measures a maximum amplitude of the focus error signal during one rotation of the optical disc 1, and stores the maximum amplitude as V(0) (S104). Next, according to an order from the focus control unit 64, the phase correction unit 78 sets the phase correction amount S to be a value obtained by adding 1 to the current phase correction amount S for the memory output control unit 77 (S106). In this state, the focus error signal measurement unit 65 measures the maximum amplitude of the focus error signal during one rotation of the optical disc 1, and stores the maximum amplitude as V(1). Measurement of the maximum amplitude of the focus error signal is repeated so that the phase correction amount S is increased by 1 each time the maximum amplitude of the focus error signal is measured, while whether or not measurements of a predetermined number of times have been completed is confirmed (S103). When the predetermined number of times of measurements have completed, the phase correction amount S with which the maximum amplitude is the smallest is obtained and is set as an optimal phase correction amount S, and then, the operation is completed (S107).

Note that when the phase correction amount is set to be too large, the focus error signal is too large, and focus control might be unstable (see FIG. 16). Even when the number of times of performed measurements has not yet reached the predetermined number, the measurement is stopped if the maximum amplitude of the focus error signal exceeds a predetermined limit (S105), and the phase correction amount S with which the maximum amplitude is the smallest of the measured maximum amplitudes is obtained and is set as an optimal phase correction amount S, and then, the operation is completed (S107).

As described above, in the focus position control apparatus of this embodiment, the optimal phase correction amount with which the focus error signal can be reduced to be minimal can be obtained, regardless of the amount of a phase delay between a clock position when data is read from a memory and a clock position when the data has been written in the memory. Therefore, according to this embodiment, a focus position control apparatus having a stable control characteristic in any case can be realized. Moreover, the focus position control apparatus of this embodiment can be varied to be a focus position control apparatus for performing the tracking control of the second embodiment. That is, measurement is performed to a tracking error signal, instead of a focus error signal, to determine the phase correction amount S with which the maximum amplitude of the tracking error signal is the smallest. Thus, regardless of the amount of a phase delay between a clock position when data is read from a memory and a clock position when the data has been written to the memory, an optimal phase correction amount with which the tracking error signal can be reduced to be minimal can be obtained, and thus, a focus position control apparatus having a stable control characteristic in any case can be realized.

### Fourth Embodiment

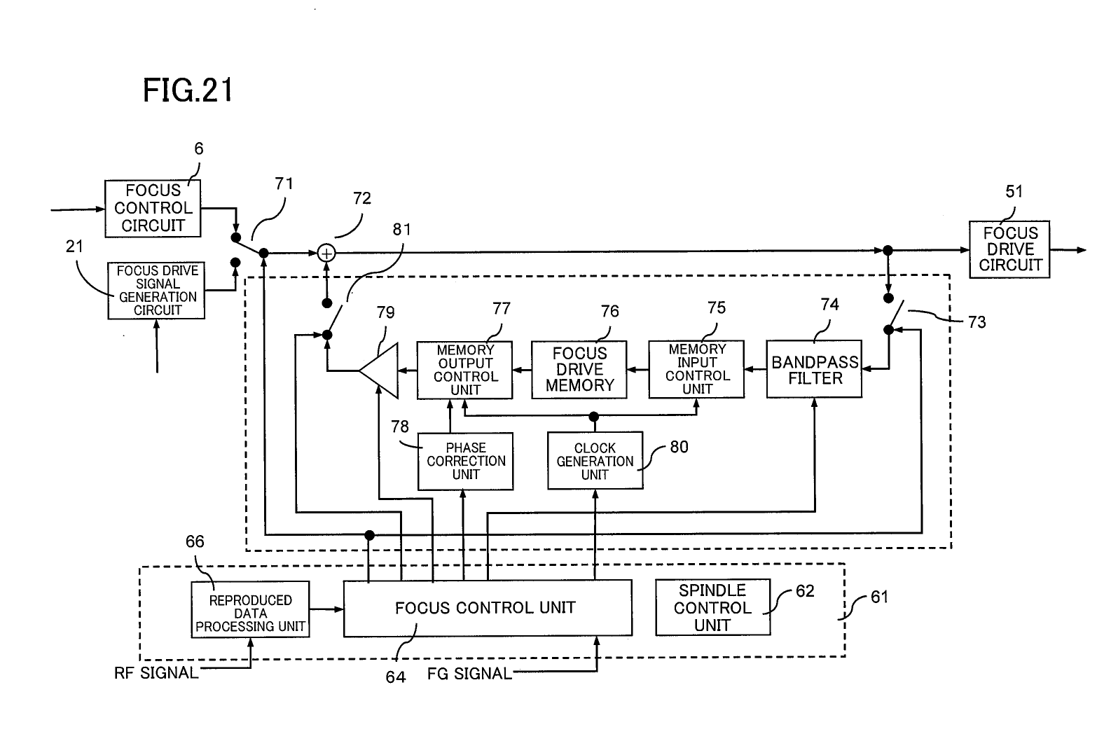

A focus position control apparatus according to a fourth embodiment of the present invention is configured so that a delay correction amount with which a reproduction jitter obtained from an RF signal is minimal is obtained as an optimal phase correction amount S. A case where the focus position control apparatus of this embodiment is a focus control apparatus will be hereinafter described as an example. The focus position control apparatus of this embodiment and an optical disc apparatus in which the focus position control apparatus is incorporated have similar configurations to those of the first embodiment (see FIG. 1). A reproduced data processing unit 66 measures a reproduction jitter based on an RF signal generated in an RF signal generation circuit 54. FIG. 21 illustrates a configuration of a focus memory processing circuit 23 in the focus position control apparatus of this embodiment. The measured reproduction jitter value is sent to a focus control unit 64, and the amplitude of the measured reproduction jitter is determined. The reproduction jitter is measured while a clock number S as a phase correction amount is changed, and the clock number S with which the reproduction jitter is minimal is determined.

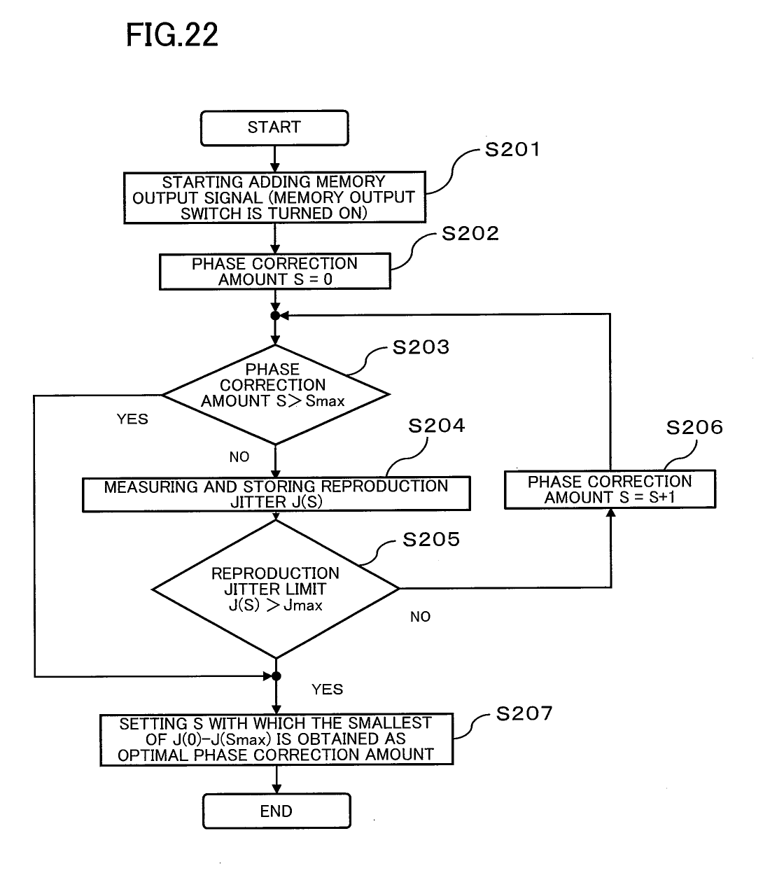

The operation of the focus position control apparatus of this embodiment will be described with a flowchart of FIG. 22. First, storing and reading of memory data is performed to a focus drive memory 76, a memory output signal is added to a focus control signal, and focus control is performed using the focus control signal to which the memory output signal has been added. In this state, i.e., in a state where the memory output switch 81 is in an on state, the operation is started (S201). A phase correction unit 78 sets the phase correction amount S=0 for a memory output control unit 77 according to an order from the focus control unit 64 (S202). In a state where the memory output control unit 77 takes out memory data and outputs the taken data with the phase correction amount S=0, the reproduced data processing unit 66 measures the reproduction jitter from the RF signal, and sends the amplitude of the reproduction jitter as J(0) to the focus control unit 64. The amplitude J(0) is stored in the focus control unit 64 (S204). Next, according to an order from the focus control unit 64, the phase correction unit 78 sets the phase correction amount S to be a value obtained by adding 1 to the current phase correction amount S for the memory output control unit 77 (S206). In this state, the reproduced data processing unit 66 measures the reproduction jitter, and stores the amplitude of the reproduction jitter as J(1). Measurement of the reproduction jitter is repeated so that the phase correction amount S is increased by 1 each time the reproduction jitter is measured, while whether or not measurements of a predetermined number of times have been completed is confirmed (S203). When measurements of the predetermined number of times have been completed, the phase correction amount S with which the reproduction jitter is the smallest of the measured reproduction jitters is obtained and is set as an optimal phase correction amount S, and then, the operation is completed (S207).

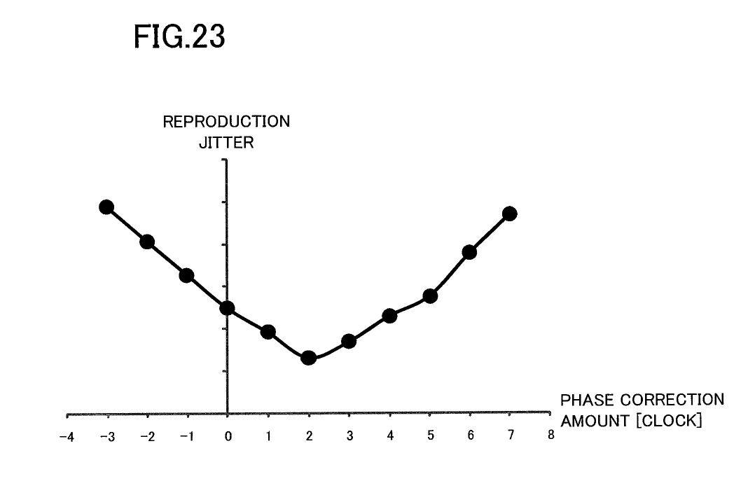

FIG. 23 illustrates change in reproduction jitter when the phase correction amount S is changed. As shown in FIG. 23, a phase correction amount with which the reproduction jitter is minimal exists, and regardless of the direction in which the phase correction amount is moved from the phase correction amount with which the reproduction jitter is the smallest, the reproduction jitter tends to be degraded. Therefore, even when the phase correction amount is changed in an opposite direction to an optimal direction in a state where the phase correction amount is greatly shifted, the reproduction jitter is only increased and an optimal point is not found, and furthermore, focus control might be possibly unstable. Therefore, even when the number of times of performed measurements has not yet reached the predetermined number, the measurement is stopped if the reproduction jitter exceeds a predetermined limit (S205), and the phase correction amount S with which the reproduction jitter is the smallest of the measured reproduction jitters is obtained and is set as an optimal phase correction amount S, and then, the operation is completed (S207).

As described above, with the focus position control apparatus of this embodiment, regardless of the amount of a phase delay between a clock position when data is read from a memory and a clock position when the data has been written to the memory, an optimal phase correction amount with which a best reproduction characteristic is achieved can be obtained, and thus, an optical disc apparatus having a stable reproduction characteristic in any case can be realized.

### Fifth Embodiment

A focus position control apparatus according to a fifth embodiment of the present invention is configured so that a delay correction amount with which the amplitude of an RF signal is maximal is obtained as an optimal phase correction amount S. A case where the focus position control apparatus of this embodiment is a focus control apparatus will be hereinafter described as an example. The focus position control apparatus of this embodiment and an optical disc apparatus in which the focus position control apparatus is incorporated have similar configurations to those of the fourth embodiment (see FIGS. 1 and 21). The fifth embodiment is different from the fourth embodiment in that, instead of a reproduction jitter, the amplitude of an RF signal is measured. That is, the measured value of the amplitude of an RF signal in a reproduced data processing unit 66 is sent to a focus control unit 64. The focus control unit 64 determines the amplitude of the RF signal. The amplitude of the RF signal is measured while a clock number S as a phase correction amount is changed, and the clock number S with which the amplitude of the RF signal is the largest is determined.

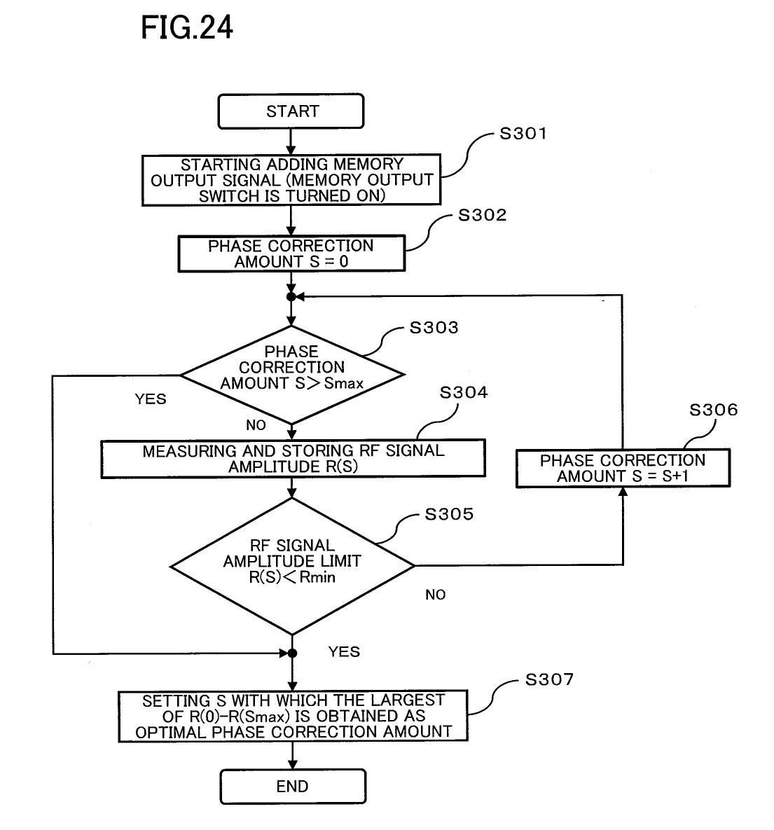

The operation of the focus position control apparatus of this embodiment will be described with a flowchart of FIG. 24. First, storing and reading of memory data is performed to a focus drive memory 76, a memory output signal is added to a focus control signal, and focus control is performed using the focus control signal to which the memory output signal has been added. In this state, i.e., in a state where a memory output switch 81 is in an on state, the operation is started (S301). A phase correction unit 78 sets the phase correction amount S=0 for a memory output control unit 77 according to an order from a focus control unit 64 (S302). In a state where the memory output control unit 77 takes out memory data and outputs the taken data with the phase correction amount S=0, the reproduced data processing unit 66 measures the amplitude of the RF signal, and sends the amplitude as R(0) to the focus control unit 64. The amplitude R(0) is stored in the focus control unit 64 (S304). Next, according to an order from the focus control unit 64, the phase correction unit 78 sets the phase correction amount S to be a value obtained by adding 1 to the current phase correction amount S for the memory output control unit 77 (S306). In this state, the reproduced data processing unit 66 measures the amplitude of the RF signal, and stores the amplitude as R(1). Measurement of the amplitude of the RF signal is repeated so that the phase correction amount S is increased by 1 each time the amplitude of the RF signal is measured, while whether or not measurements of a predetermined number of times have been completed is confirmed (S303). If measurements of the predetermined number of times have been completed, the phase correction amount S with which the measured amplitude of the RF signal is the largest is obtained and is set as an optimal phase correction amount S, and then, the operation is completed (S307). Even when the number of times of performed measurements has not yet reached the predetermined number of times, the measurement is stopped if the amplitude of the RF signal falls below a predetermined limit (S305). Then, the phase correction amount S with which the amplitude of the RF signal is the largest of the measured amplitudes of the RF signals is obtained and is set as an optimal phase correction amount S, and then, the operation is completed (S307).

As described above, with the focus position control apparatus of this embodiment, regardless of the amount of a phase delay between a clock position when data is read from a memory and a clock position when the data has been written to the memory, an optimal phase correction amount with which a best reproduction characteristic is achieved can be obtained, and thus, an optical disc apparatus having a stable reproduction characteristic in any case can be realized.

### Sixth Embodiment

A focus position control apparatus according to a sixth embodiment of the present invention is configured so that, even when normal focus control or normal tracking control is stopped, a memory output signal is output, the memory output signal is added to a drive signal output by a tracking drive signal generation circuit 22 to drive a focus actuator 7 or a tracking actuator 8, and thus, a focus position of an optical beam 39 is caused to follow a surface runout or an eccentricity. With this configuration, the operation of transition of focus control or tracking control after focus jump, tracking jump, inter-track movement can be stabilized. A case where focus position control of the focus position control apparatus of this embodiment is tracking control will be hereinafter described as an example. The focus position control apparatus of this embodiment has a similar configuration to that of the second embodiment (see FIGS. 17 and 18).

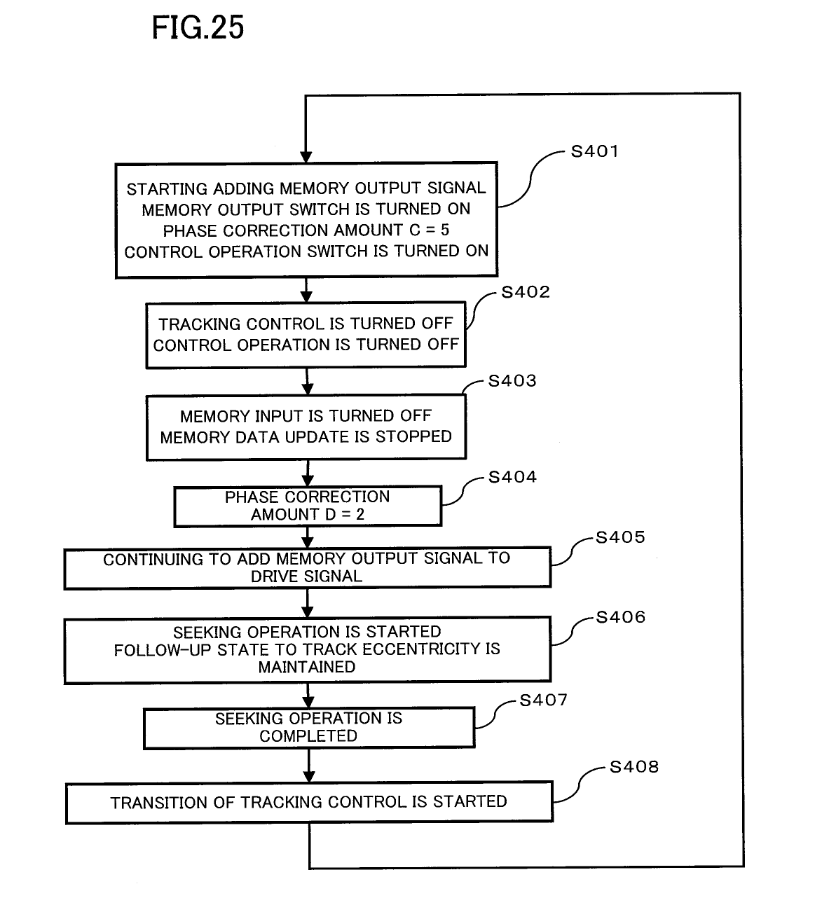

The operation of the focus position control apparatus of this embodiment will be described with reference to a flowchart of FIG. 25. First, memory data stored in a tracking drive memory 82 is output as a memory output signal, the memory output signal is added to a tracking control signal in a state where a memory output switch 133 is in an on state, and tracking control is executed using the tracking control signal to which the memory output signal has been added. In this state, the operation is started. In this case, the phase correction amount S is set to be a value with which the maximum amplitude of the tracking error signal is the smallest, or a value with which a best reproduction characteristic is achieved. The phase correction amount is set as a phase correction amount C (S401). In this state, for example, when the operation is shifted to a seek operation (inter-track movement), a control operation switch 87 is switched to be connected to the tracking drive signal generation circuit 22, and thus, the tracking control operation is stopped (S402). At the same time, a memory input switch 134 is turned off, and update of memory data in the tracking drive memory 82 is stopped (S403). Also, at the same time, a phase correction unit 89 changes the phase correction amount from the phase correction amount C which has been currently set to a phase correction amount D according to an order of a tracking control unit 67 (S404). The phase correction amount D is a value with which a control residual in a low frequency band including a rotation frequency is minimal. Thus, an optimal memory output signal for following an eccentricity can be obtained. In this step, the memory output switch 133 is still in an on state, and the stored memory data as a memory output signal is added to a drive signal by an adder 88 and is input to the tracking drive circuit 56 (S405). The tracking actuator 8 is driven by the drive signal to which the memory output signal has been added, and the state in which the focus position of the optical beam 39 follows the eccentricity of a track is maintained (S406). Thereafter, the movement of the optical head 3 in the radial direction by the seek operation is completed, and a transition of tracking control is started (S407).

Normally, a transition of tracking control can be stabilized by the transition of tracking control at the time when a track traverse frequency due to an eccentricity of a track is relatively low. In this case, the tracking actuator 8 has been driven by the optimal memory output signal for following the eccentricity obtained since the start of the seek operation. Thus, at the time when the movement of the optical head 3 is completed to start a transition of tracking control, the track traverse frequency of the optical beam 39 has become low. Therefore, a stable transition of tracking control can be immediately made. At the time of starting the transition, the control operation switch 87 is switched to be connected to the tracking control circuit 55 (S408). Also, at the same time, the phase correction unit 89 returns the phase correction amount from the phase correction amount D which has been currently set to the phase correction amount C according to an order of the tracking control unit 67. Then, the memory input switch 134 is turned on, and writing to the tracking drive memory 82 is restarted (S401).

As described above, while tracking control is performed, the phase correction amount is set to be a value with which the maximum amplitude of the tracking error signal is the smallest. For example, as shown in FIG. 12, the phase correction amount is set to be 5 so that high order frequency components can be sufficiently reduced. While tracking control is stopped, high order frequency components do not have to be reduced, and thus, as shown in FIG. 11, the phase correction amount is set to be 2 so that the rotation frequency component can be reduced.

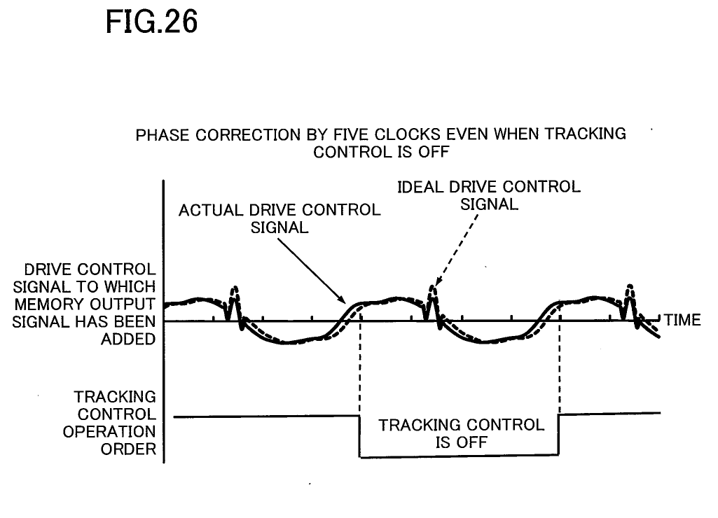

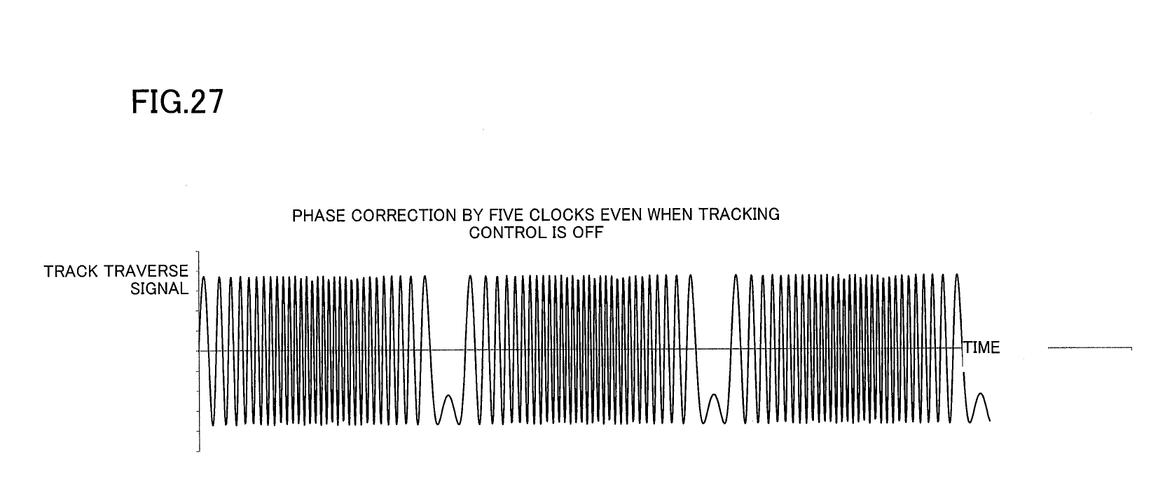

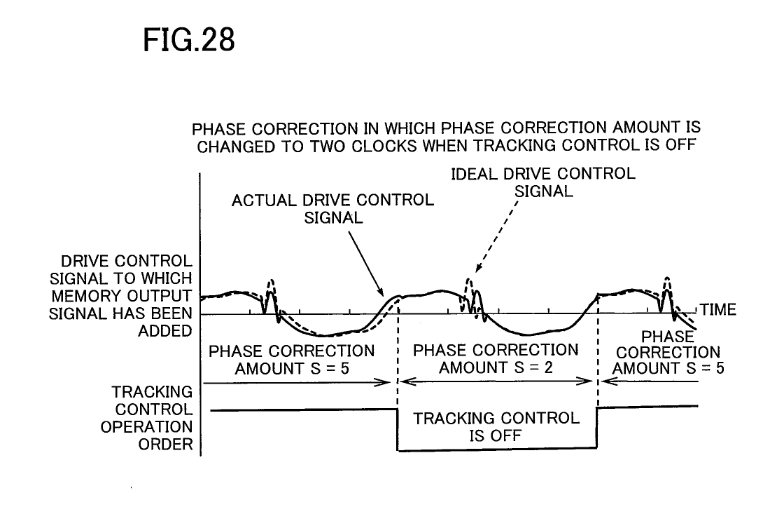

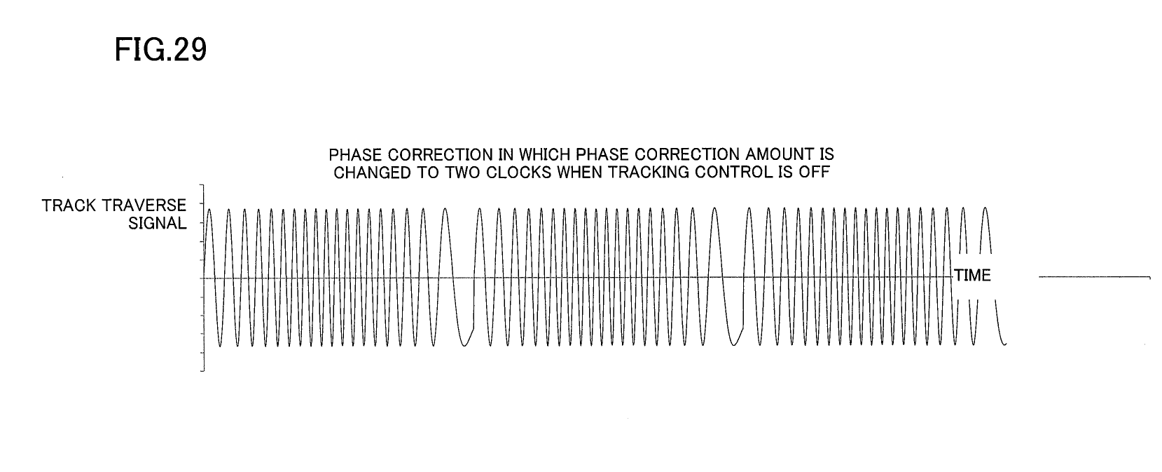

FIG. 26 illustrates a drive signal when the phase correction amount is set to be 5, which is an optimal value for tracking control operation, even when tracking control is stopped. In this case, the phase of the rotation frequency component is advanced too much, and thus, the following capability to follow an eccentricity is reduced. FIG. 27 illustrates a track traverse signal of the optical beam 39 in the case of FIG. 26. In contrast, in FIG. 28, since the phase correction amount is changed from 5 to 2 when tracking control is stopped, the phase of the rotation frequency component is optimal, and thus, the following capability to follow an eccentricity is improved. FIG. 29 illustrates a track traverse signal of the optical beam 39 in the case of FIG. 28. The track traverse frequency of FIG. 29 is lower than that of FIG. 27.

As described above, with the focus position control apparatus of this embodiment, a stable transition of tracking control is allowed. Thus, not only the recording/reproduction characteristic can be improved, but also reduction in access speed can be realized by stabilizing a seek operation and reducing a processing time of the seek operation.

Note that similar advantages to those described above for a surface runout of the optical disc 1 can be achieved also in focus control. That is, the focus position of the optical beam 39 can be caused to follow a surface runout even during a focus jump operation, and thus, a stable transition of focus control after a focus jump operation can be realized.

### Seventh Embodiment

A focus position control apparatus according to a seventh embodiment of the present invention is configured to include a drive memory for low frequency and a drive memory for high frequency separately provided therein, thereby separately optimizing their respective phase correction amounts. Furthermore, in the focus position control apparatus of this embodiment, unnecessary frequency components in a memory input signal can be blocked by each of bandpass filters separately provided. The focus position control apparatus of this embodiment and an optical disc apparatus in which the focus position control apparatus is incorporated basically have similar configurations to those of the first embodiment (see FIG. 1).

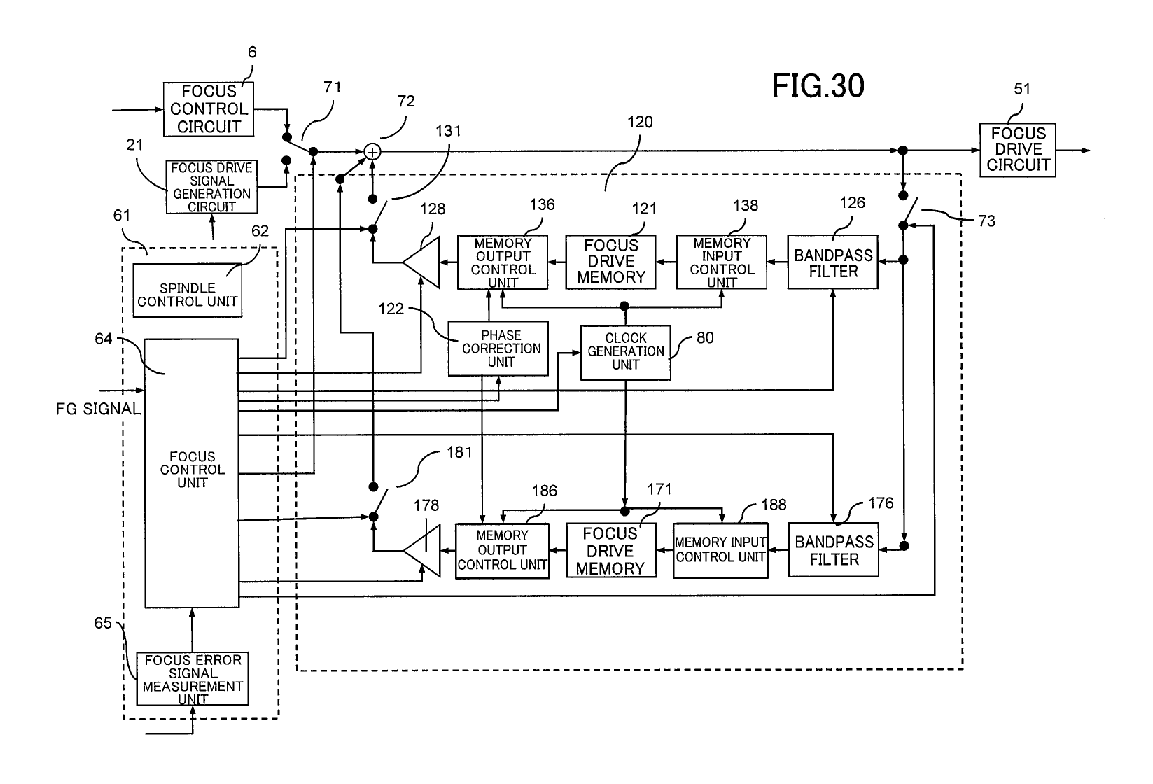

FIG. 30 illustrates a configuration of a focus memory processing circuit 23 in the focus position control apparatus of this embodiment. A focus control signal is input to each of bandpass filters 126 and 176 via a memory input switch 73. The bandpass filter 126 passes only low frequency components in a focus control signal, including a rotation frequency component, generates a memory input signal, and outputs the generated memory input signal to a memory input control unit 138. The bandpass filter 176 passes only high frequency components in a focus control signal at a frequency of a local surface runout and the like, extracts a signal in a desired frequency band to generate a memory input signal, and outputs the generated memory input signal to a memory input control unit 188. Each of the frequency bands which the bandpass filters 126 and 176 pass can be controlled to be a desired band using a filter control signal from a focus control unit 64.

Each of the memory input control units 138 and 188 stores a memory input signal as memory data at a predetermined clock address in each of focus drive memories 121 and 171 in synchronization with a common clock signal. The clock signal is a rotation synchronizing signal, which is generated in a clock generation unit 80 by multiplying an FG signal input to the clock generation unit 80 via the focus control unit 64. As the optical disc 1 rotates once, one round of clock addresses is completed. Each of the memory output control units 136 and 186 outputs the memory data stored at an associated one of specified clock addresses as a memory output signal, based on an order signal sent from a phase correction unit 122. Each of the memory output signals is amplified with a desired gain by an associated one of amplifiers 128 and 178, and is added to the focus control signal by the adder 72 via an associated one of memory output switches 131 and 181. The gain of each of the amplifiers 128 and 178 is controlled to be a desired gain by a gain control signal from the focus control unit 64. The focus control signal to which the memory output signal have been added is input to a focus drive circuit 51, and is converted to a voltage to drive the focus actuator 7.

In the optical disc apparatus in which the focus control apparatus (focus position control apparatus) of this embodiment having the above-described configuration is incorporated, steps before the operation of the focus control apparatus is started are similar to those of the first embodiment. Each step is executed based on an order from a system controller 61. First, a traverse motor control circuit 18 drives a traverse motor 14 according to an order from the system controller 61 to move an optical head 3 to a desired radial position. Next, a spindle motor control circuit 5 rotationally drives an optical disc 1 at a desired rotation frequency, which is specified by the system controller 61. In this state, the operation of the focus control apparatus is started.

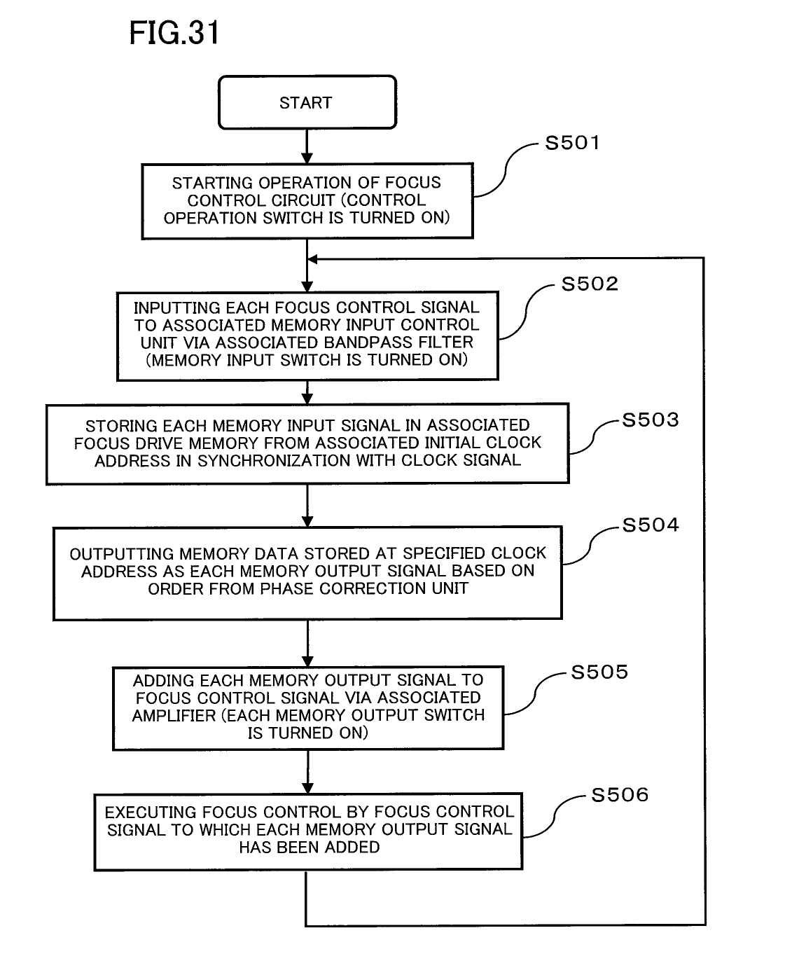

Next, details of the operation of the focus control apparatus of this embodiment will be described with reference to a flowchart of FIG. 31. First, an objective lens 4 is moved up or down by a drive signal output by a focus drive signal generation circuit 21 according to an order from the focus control unit 64. Then, when the focus error signal has become close to zero, i.e., when a focus of the optical beam 39 has become close to a disc recording surface, a focus control circuit 6 is operated according to a control operation order, and a control operation switch 71 is switched so that a focus control signal is input to the focus drive circuit 51 (S501). At the same time, a memory input switch 73 is turned on, so that the focus control signal passes through each of the bandpass filters 126 and 176, and is input to each of the memory input control units 138 and 188 (S502). Each of the memory input control units 138 and 188 sequentially stores an associated one of the memory input signals as memory data in an associated one of the focus drive memories 121 and 171 from an initial clock address in synchronization with a clock signal, and when the optical disc 1 has rotated once since a start of storing memory input signals, storing of the memory input signals is repeated from the initial clock address (S503). When the optical disc 1 has rotated once or more since the start of storing the memory input signals, each of the memory output control units 136 and 186 starts outputting, as a memory output signal, memory data stored at a specified clock address in synchronization with a clock, based on an order signal from a phase correction unit 122 (S504). At the same time, each of the memory output switches 131 and 181 is turned on, so that each of the memory output signals is added to the focus control signal via an associated one of the amplifiers 128 and 178 (S505), and focus control is executed by the focus control signal to which the memory output signals have been added (S506).

Details of the operation after each of the memory input signals is input to an associated one of the memory input control units 138 and 188 (S502) until memory data is output as a memory output signal (S504) are similar to those of the first embodiment. A feature of this embodiment is that the bandpass filter, the focus drive memory, the memory output control unit, the amplifier, and the memory output switch are provided for each of low frequency components including the rotation frequency component and high frequency components including a frequency component of a local surface runout, i.e., two of each of those components are provided separately for the low frequency components and the high frequency components, and furthermore, the phase correction amount S for the low frequency components is different from that for the high frequency components.

When both of a large surface runout of the rotation frequency and a local surface runout at a frequency which is about 10 times the rotation frequency due to a distortion of the optical disc 1 exist in the optical disc 1, control residuals due to the surface runout and the local surface runout both have to be reduced (see FIGS. 9-14). However, the amount of a delay of a memory output signal from a focus control signal caused by a processing time of a hardware or a software differs between respective frequency bands of the surface runout and the local surface runout. Accordingly, the optimal value of a phase correction amount for a phase delay between a clock position when data is written to a drive memory and a clock position where data is read varies. Even in such a case, the focus position control apparatus of this embodiment can perform focus position control.

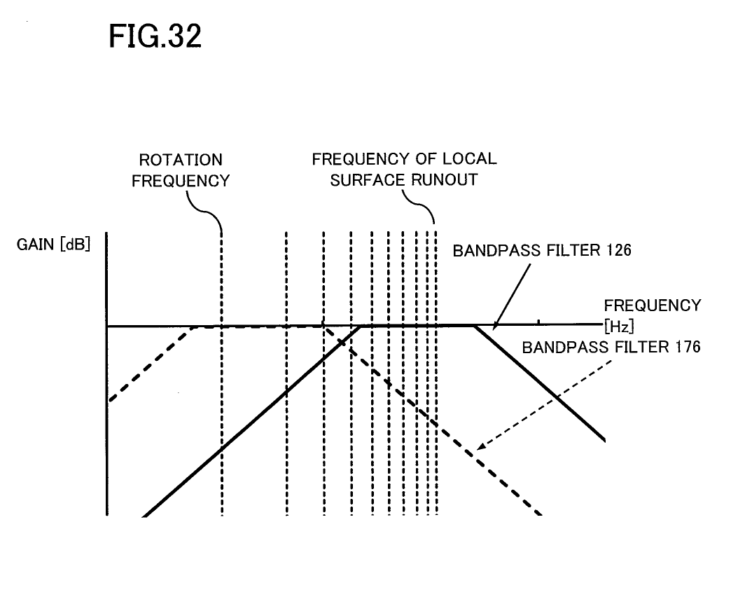

FIG. 32 illustrates gain characteristics of the bandpass filters 126 and 176. The bandpass filter 126 passes only low frequency components in a focus control signal including a rotation frequency. The bandpass filter 176 passes only high frequency components in a focus control signal, such as a frequency of a local surface runout.

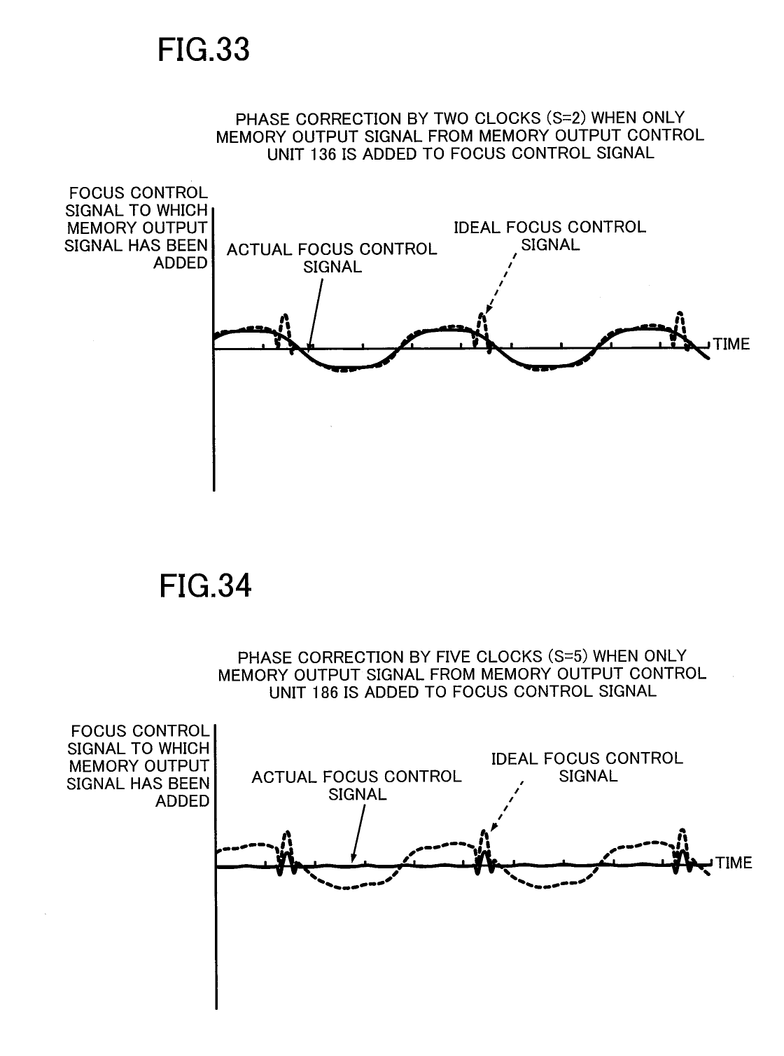

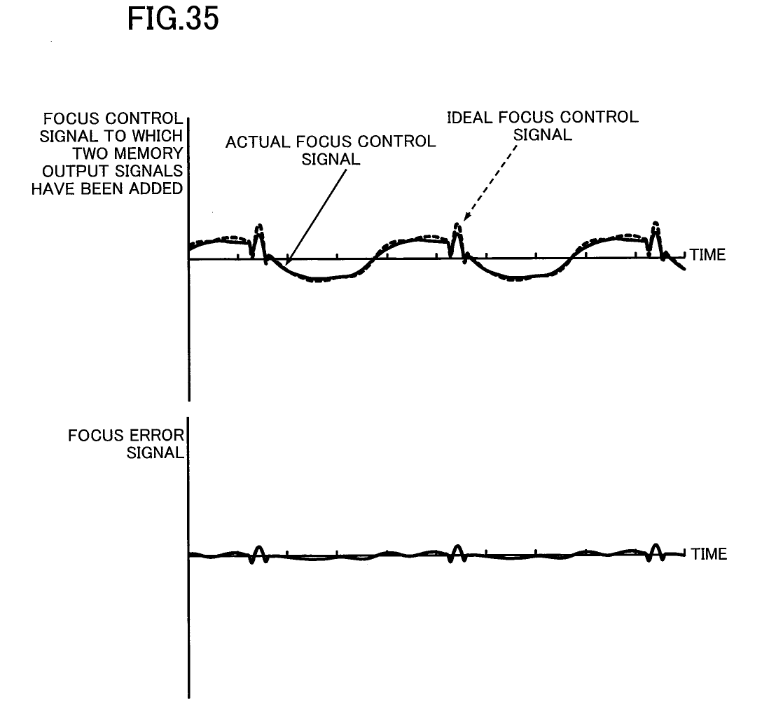

FIG. 33 illustrates change with time in a focus control signal to which a memory output signal has been added, when a memory input signal which has passed through the bandpass filter 126 is stored in the focus drive memory 121, and the phase correction amount S is set to be 2 so that a phase delay in a frequency band around the rotation frequency can be corrected. As can be seen from FIG. 33, a frequency component of a local surface runout is not included, and the phase delay of the rotation frequency component is substantially eliminated. FIG. 34 illustrates change with time in a focus control signal to which a memory output signal has been added, when a memory input signal which has passed through the bandpass filter 176 is stored in the focus drive memory 171 and the phase correction amount S is set to be 5 so that a phase delay in a frequency band around a frequency of a local surface runout can be corrected. As can be seen from FIG. 34, the rotation frequency component is not included, and the phase delay of the frequency component of the local surface runout is substantially eliminated. In contrast, FIG. 35 illustrates a focus control signal to which two memory output signals have been added, and a focus error signal at the same time. As can be seen from FIG. 35, a phase delay of each of the rotation frequency component and the high order frequency component has been eliminated, and the amplitude of the focus error signal is reduced to be small.

As described above, with the focus position control apparatus of this embodiment, both of a phase delay of the rotation frequency component in a focus control signal and a phase delay of a high order frequency component in the focus control signal hardly occur, so that a control residual can be reduced to be very small. Similar to the focus position control apparatus of the sixth embodiment, even when focus position control is not performed, only the memory output switch 131 is turned on, and a memory output signal from the memory output control unit 136 is added to a drive signal. Thus, a large reduction rate can be achieved in a low frequency band, and accordingly, a stable transition of focus position control is allowed. Therefore, not only the recording/reproduction characteristic of the optical disc apparatus can be improved, but also reduction in access speed can be realized by stabilizing a seek operation and reducing a processing time of the seek operation.

### Eighth Embodiment

A focus position control apparatus according to an eighth embodiment is configured so that a memory output control unit for low frequency and a memory output control unit for high frequency are provided for one drive memory, respective phase correction amounts for the memory output control units can be optimized separately, and furthermore, unnecessary frequency components in each of memory input signals of the memory output control units can be blocked by an associated one of bandpass filters separately provided. The focus position control apparatus of this embodiment and an optical disc apparatus in which the focus position control apparatus is incorporated basically have similar configurations to those of the first embodiment (see FIG. 1).

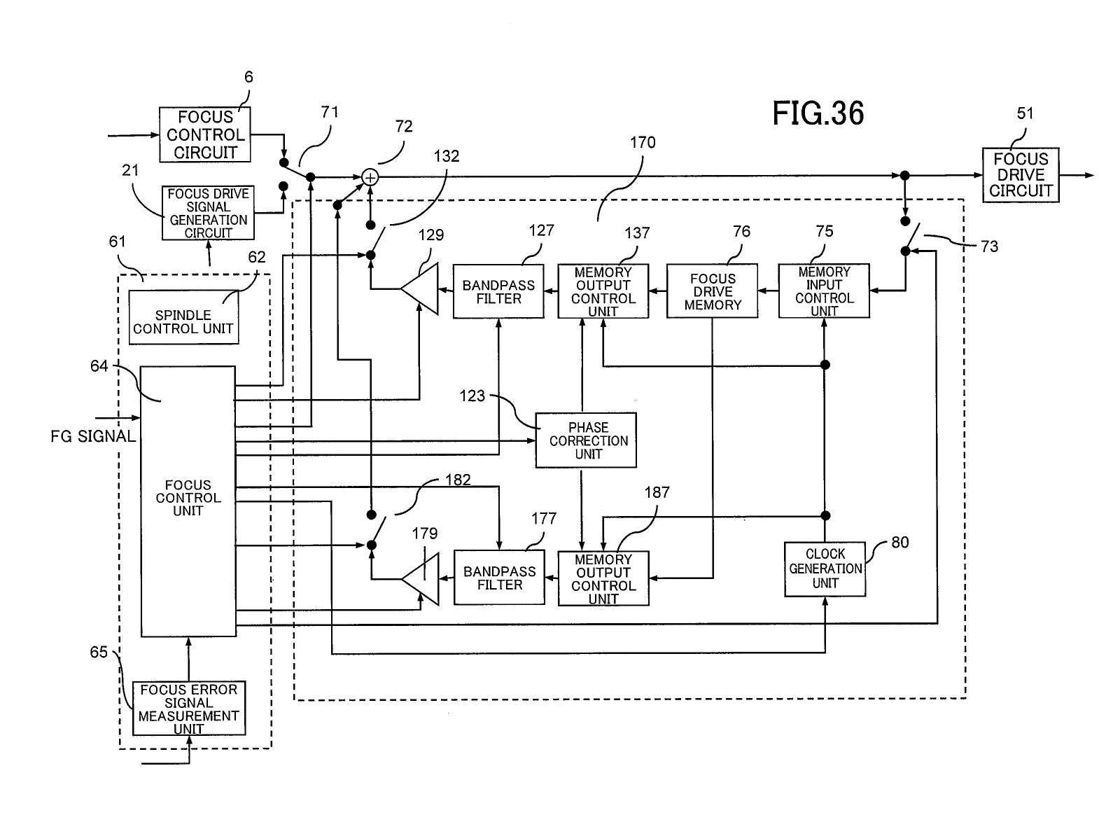

FIG. 36 illustrates a configuration of a focus memory processing circuit 23 in the focus position control apparatus of this embodiment. A focus control signal is input to a memory input control unit 75 via a memory input switch 73. The memory input control unit 75 stores a memory input signal as memory data at a predetermined clock address of a focus drive memory 76 in synchronization with a clock signal. The clock signal is a rotation synchronizing signal, which is generated in a clock generation unit 80 by multiplying an FG signal input to the clock generation unit 80 via the focus control unit 64. As the optical disc 1 rotates once, one round of clock addresses is completed. Each of the memory output control units 137 and 187 outputs the memory data stored at a specified clock address as a memory output signal, based on an associated one of order signals sent from a phase correction unit 123 to the memory output control units 137 and 187. Each of the memory output signals is input to an associated one of bandpass filters 127 and 177. The bandpass filter 127 passes only low frequency components in the memory output signal from the memory output control unit 137 including the rotation frequency, and inputs the low frequency components to an amplifier 129. The bandpass filter 177 passes only high frequency components in the memory output signal from the memory output control unit 187, such as a frequency of a local surface runout, and inputs the high frequency components to an amplifier 179. Each of the frequency bands which the bandpass filters 127 and 177 pass can be controlled to be a desired band by a filter control signal from a focus control unit 64.

Each of the memory output signals is amplified with a desired gain by an associated one of the amplifiers 129 and 179, and is added to a focus control signal by an adder 72 via an associated one of memory output switches 132 and 182. The gain of each of the amplifiers 129 and 179 is controlled to be a desired gain by a gain control signal from the focus control unit 64. The focus control signal to which the memory output signals have been added is input to the focus drive circuit 51, and is converted to a voltage to drive a focus actuator 7.

In the optical disc apparatus in which the focus control apparatus (focus position control apparatus) of this embodiment having the above-described configuration is incorporated, steps before the operation of the focus control apparatus is started are similar to those of the first embodiment. Each step is executed based on an order from a system controller 61. First, a traverse motor control circuit 18 drives a traverse motor 14 according to an order from the system controller 61 to move the optical head 3 to a desired radial position. Next, a spindle motor control circuit 5 rotationally drives the optical disc 1 at a desired rotation frequency, which is specified by the system controller 61. In this state, the operation of the focus control apparatus is started.

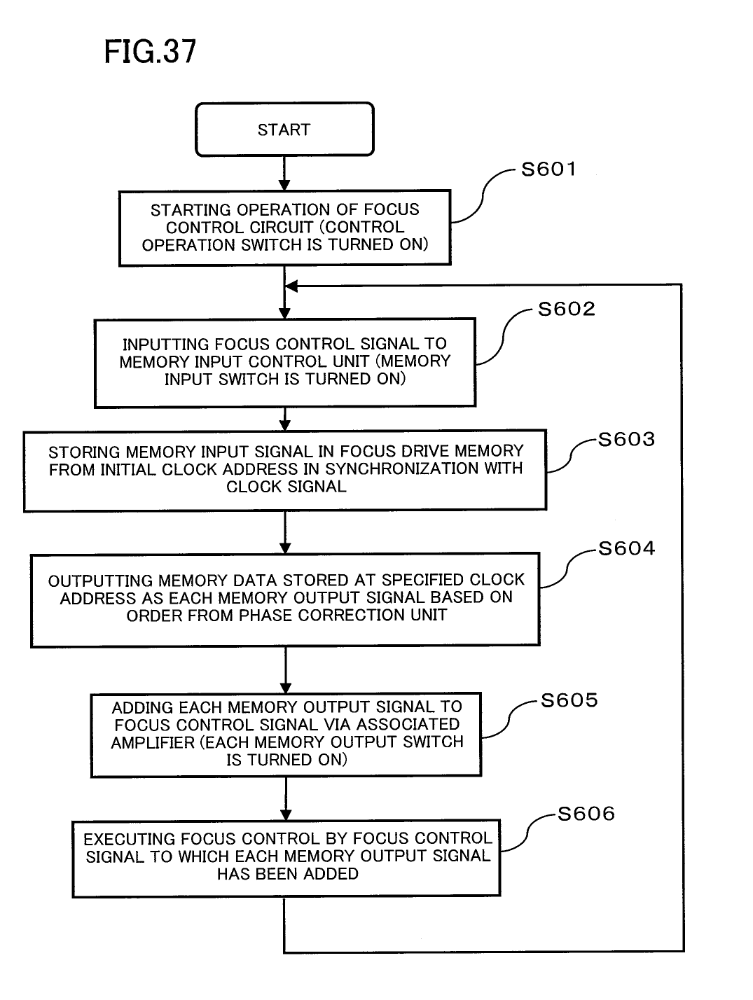

Next, details of the operation of the focus control apparatus of this embodiment will be described with reference to a flowchart of FIG. 37. First, the objective lens 4 is moved up or down by a drive signal output by a focus drive signal generation circuit 21 according to an order from the focus control unit 64. Then, when a focus error signal has become close to zero, i.e., when a focus of the optical beam 39 has become close to a disc recording surface, a focus control circuit 6 is operated according to a control operation order, and the control operation switch 71 is switched so that the focus control signal is input to the focus drive circuit 51 (S601). At the same time, the memory input switch 73 is turned on, so that the focus control signal is input to the memory input control unit 75 (S602). The memory input control unit 75 sequentially stores the memory input signal as memory data in the focus drive memory 76 from an initial clock address in synchronization with a clock signal, and when the optical disc 1 has rotated once since a start of storing memory input signals, storing of the memory input signals is repeated from the initial clock address (S603). When the optical disc 1 has rotated once or more since the start of storing the memory input signals, each of the memory output control units 137 and 187 starts outputting as a memory output signal memory data stored at a specified clock address in synchronization with a clock, based on an order signal from a phase correction unit 123 (S604). At the same time, each of memory output switches 132 and 182 is turned on, so that each one of the memory output signals passes through an associated one of the bandpass filters 127 and 177, is amplified by an associated one of the amplifiers 129 and 179, and is added to a focus control signal (S605). Then, focus control is executed by the focus control signal to which the memory output signals have been added (S606).

Details of the operation after the memory input signal is input to the memory input control unit 75 (S602) until memory data is output as a memory output signal (S604) are similar to those of the first embodiment. A feature of this embodiment is that the memory output control unit, the bandpass filter, the amplifier, and the memory output switch are provided for each of low frequency components including the rotation frequency component and high frequency components including a frequency component of a local surface runout, i.e., two of each of those components are provided separately for the low frequency components and the high frequency components, and furthermore, the phase correction amount S for the low frequency components is different from that for the high frequency components.

When both of a large surface runout at the rotation frequency and a local surface runout at a frequency which is about 10 times the rotation frequency due to a distortion of the optical disc 1 exist in the optical disc 1, control residuals due to the surface runout and the local surface runout both have to be reduced (see FIGS. 9-14). However, the amount of a delay of a memory output signal from a focus control signal caused by a processing time of a hardware or a software differs between respective frequency bands of the surface runout and the local surface runout. Accordingly, the optimal value of a phase correction amount for a phase delay between a clock position when data is written to a drive memory and a clock position when data is read varies. Even in such a case, the focus position control apparatus of this embodiment can perform focus position control.

Each of the memory output control units 137 and 187 reads memory data from a clock address corrected by a predetermined phase correction amount set by the phase correction unit 123 for each of the memory output control units 137 and 187. The phase correction amount S for the memory output control unit 137 is set to be 2 so that a phase delay in a frequency band around the rotation frequency can be corrected. In the memory output signal read with the phase correction amount set as described above, a phase is delayed in a frequency band of a local surface runout (see FIG. 11). On the other hand, the phase correction amount S for the memory output control unit 187 is set to be 5 so that a phase delay in a frequency band around a frequency of a local surface runout can be corrected. In the memory output signal read with the phase correction amount set as described above, a phase is advanced too much in a frequency band around the rotation frequency (see FIG. 12). Thus, when focus control is performed by adding the memory output signals to the focus control signal, a control residual can be reduced to be smaller, as compared to normal focus control. However, a sufficient control reduction rate might not be achieved.

Therefore, the focus position control apparatus of this embodiment is configured so that the memory output signals are caused to separately pass through the bandpass filters 127 and 177. The gain characteristics of the bandpass filters 127 and 177 are similar to those of the bandpass filters 126 and 176 of the seventh embodiment (see FIG. 32). Similar to the bandpass filter 126, the bandpass filter 127 passes only low frequency components in a focus control signal including the rotation frequency component. Similar to the bandpass filter 176, the bandpass filter 177 passes only high frequency components in the focus control signal, such as a frequency of a local surface runout.

Accordingly, in the memory output signal from the memory output control unit 137, the frequency band of a local surface runout in which a phase is delayed is blocked by the bandpass filter 127. Also, in the memory output signal from the memory output control unit 187, the frequency band around the rotation frequency in which a phase is advanced too much is blocked by the bandpass filter 177. That is, a phase in a frequency band whose control residual is to be reduced is optimized using each of memory output signals, and moreover, unnecessary frequency components other than frequency components in the frequency band whose control residual is to be reduced can be removed. Thus, an optical beam can be caused to follow each of low frequency components due to a surface runout and the like and high frequency components due to a local surface runout and the like, so that a control residual can be reduced to be sufficiently small.

As described above, with the focus position control apparatus of this embodiment, each of a phase delay of a rotation frequency component in a focus control signal and a phase delay of a high order frequency component in the focus control signal hardly occurs. Thus, a focus position control apparatus in which a control residual can be reduced to be very small can be realized. Similar to the focus position control apparatus of the sixth embodiment, even when focus control is stopped, only the memory output switch 132 is turned on, and the memory output signal from the memory output control unit 137 is added to a drive signal. Thus, a large reduction rate can be achieved in a low frequency band, so that a stable transition of tracking control is allowed. Therefore, not only the recording/reproduction characteristic of an optical disc apparatus can be improved, but also reduction in access speed can be realized by stabilizing a seek operation and reducing a processing time of the seek operation.

### INDUSTRIAL APPLICABILITY

A focus position control apparatus according to the present invention is applicable to an optical disc apparatus in which an optical disc is irradiated with an optical beam, thereby recording/reproducing information on the optical disc.

### DESCRIPTION OF REFERENCE CHARACTERS

3 Optical Head
6 Focus Control Circuit (First Control Unit)
7 Focus Actuator (Drive Unit)
8 Tracking Actuator (Drive Unit)
21 Focus Drive Signal Generation Circuit (Second Control Unit)
22 Tracking Drive Signal Generation Circuit (Second Control Unit)
52 Focus Error Signal Generation Circuit (Error Signal Generation Unit)
53 Tracking Error Signal Generation Circuit (Error Signal Generation Unit)
55 Tracking Control Circuit (First Control Unit)
65 Focus Error Signal Measurement Unit (Reproduced Signal Measurement Unit)
66 Reproduced Data Processing Unit (Reproduced Signal Measurement Unit)
68 Tracking Error Signal Measurement Unit (Reproduced Signal Measurement Unit)
72 Adder (Adding Unit)
74 Bandpass Filter (Filter Unit)
76 Focus Drive Memory (Memory Unit)
77 Memory Output Control Unit (Memory Data Output Unit)
78 Phase Correction Unit (Phase Correction Unit)
80 Clock Generation Unit (Rotation Synchronizing Signal Generation Unit)
82 Tracking Drive Memory (Memory Unit)
83 Bandpass Filter (Filter Unit)
85 Memory Output Control Unit (Memory Data Output Unit)
88 Adder (Adding Unit)
89 Phase Correction Unit (Phase Correction Unit)
121 Focus Drive Memory (First Memory Unit)

What is claimed is:

1. A focus position control apparatus for control of a focus position of an optical beam, the apparatus comprising:
an error signal generation unit configured to generate, based on an output signal from an optical head configured to irradiate an optical disc in which a track is formed on a recording surface with an optical beam to record or reproduce data, an error signal indicating an amount of a shift of a focus position of the optical beam from a desired position;
a first control unit configured to generate, based on the error signal, a first control signal for controlling the focus position of the optical beam to a desired position;
a second control unit configured to generate, when driving of the optical head based on the error signal is not performed, a second control signal for controlling the focus position of the optical beam to a desired position;
a rotation synchronizing signal generation unit configured to generate a clock signal synchronized with a rotation of the optical disc;
a memory unit configured to sequentially store, as memory data, a control signal for controlling the focus position of the optical beam to a desired position in synchronization with the clock signal at an associated one of clock addresses whose one round is completed as the optical disc rotates once;
a memory data output unit configured to sequentially read the memory data stored in the memory unit in synchronization with the clock signal;
a phase correction unit configured to correct, when the memory data output unit reads the memory data from the memory unit, a phase shift between a clock address for reading and a clock address for storing;
a control operation switch configured to receive the first and second control signals and selectively output one of the first control signal and the second control signal so that when the driving of the optical head based on the error signal is to be performed, the first control signal is output, and otherwise, the second control signal is output; and
an adding unit configured to add an output signal of the memory data output unit to an output signal of the control operation switch to generate the control signal,
wherein
the phase correction unit corrects the phase shift both when the driving of the optical head based on the error signal is performed and when the driving is not performed, and
when the driving of the optical head based on the error signal is not performed, input of the control signal to the memory unit is blocked, and connection of the memory data output unit with the adding unit is maintained to control the focus position of the optical beam using the control signal obtained by adding the memory data stored in the memory unit to the second control signal.

2. The focus position control apparatus of claim 1, wherein
when the driving of the optical head based on the error signal is performed, the phase correction unit corrects the phase shift so that a frequency component in the error signal desired to be reduced is reduced.

3. The focus position control apparatus of claim 2, wherein
when the driving of the optical head based on the error signal is performed, the phase correction unit corrects the phase shift so that a frequency component in the error signal with which the error signal is maximal is reduced.

4. The focus position control apparatus of claim 1, further comprising:
a filter unit configured to extract a frequency component in a predetermined frequency band in the control signal,
wherein
the memory unit stores the control signal filtered by the filter unit.

5. The focus position control apparatus of claim 1, further comprising:
a reproduced signal measurement unit configured to measure an amplitude of a reproduced signal based on an output signal of the optical head,
wherein
when the driving of the optical head based on the error signal is performed, the phase correction unit corrects the phase shift so that the amplitude of the reproduced signal is maximal.

6. The focus position control apparatus of claim 1, further comprising:
a reproduced signal measurement unit configured to measure a jitter of a reproduced signal based on an output signal of the optical head,
wherein
when the driving of the optical head based on the error signal is performed, the phase correction unit corrects the phase shift so that the jitter of the produced signal is minimal.

7. The focus position control apparatus of claim 1, wherein
when the driving of the optical head based on the error signal is not performed, the phase correction unit corrects the phase shift to a value with which a rotation frequency component of the optical disc in the error signal generated when the driving of the optical head has been performed is reduced.

8. A focus position control apparatus for control of a focus position of an optical beam, the apparatus comprising:
an error signal generation unit configured to generate, based on an output signal from an optical head configured to irradiate an optical disc in which a track is formed on a recording surface with an optical beam to record or reproduce data, an error signal indicating an amount of a shift of a focus position of the optical beam from a desired position;
a first control unit configured to generate, based on the error signal, a first control signal for controlling the focus position of the optical beam to a desired position;
a second control unit configured to generate, when driving of the optical head based on the error signal is not performed, a second control signal for controlling the focus position of the optical beam to a desired position;
a rotation synchronizing signal generation unit configured to generate a clock signal synchronized with a rotation of the optical disc;
first and second memory units each being configured to sequentially store, as memory data, a control signal for controlling the focus position of the optical beam to a desired position in synchronization with the clock signal at an associated one of clock addresses whose one round is completed as the optical disc rotates once;
first and second memory data output units each being configured to sequentially read the memory data stored in an associated one of the first and second memory units in synchronization with the clock signal;
a phase correction unit configured to correct, when each of the first and second memory data output units reads the memory data from an associated one of the first and second memory units, a phase shift between a clock address for reading and a clock address for storing;
a control operation switch configured to receive the first and second control signals and selectively output one of the first control signal and the second control signal so that when the driving of the optical head based on the error signal is to be performed, the first control signal is output, and otherwise, the second control signal is output; and
an adding unit configured to add an output signal of each of the first and second memory data output units to an output signal of the control operation switch to generate the control signal,
wherein
the phase correction unit corrects the phase shift both when the driving of the optical head based on the error signal is performed and when the driving is not performed,
at least one of the first and second memory data output units is operated even when the driving of the optical head based on the error signal is not performed, and
when the driving of the optical head based on the error signal is not performed, input of the control signal to each of the first and second memory units is blocked, and connection of each of the first and second memory data output units with the adding unit is maintained to control the focus position of the optical beam using the control signal obtained by adding the memory data stored in each of the first and second memory units to the second control signal.

9. The focus position control apparatus of claim 8, wherein
the phase correction unit corrects the phase shift so that a frequency component in the error signal desired to be reduced is reduced.

10. The focus position control apparatus of claim 8, further comprising:
first and second filter units each being configured to extract a frequency component in a predetermined frequency band in the control signal,
wherein
the each of first and second memory units stores the control signal filtered by an associated one of the first and second filter units.

11. The focus position control apparatus of claim 10, wherein
at least one of the first and second filter units extracts a rotation frequency component of the optical disc in the control signal.

12. The focus position control apparatus of claim 8, wherein
when the driving of the optical head based on the error signal is not performed, the phase control unit corrects the phase shift to a value with which a rotation frequency component of the optical disc in the error signal generated when the driving of the optical head has been performed is reduced.

13. A focus position control apparatus for control of a focus position of an optical beam, the apparatus comprising:
an error signal generation unit configured to generate, based on an output signal from an optical head configured to irradiate an optical disc in which a track is formed on a recording surface with an optical beam to record or reproduce data, an error signal indicating an amount of a shift of a focus position of the optical beam from a desired position;
a first control unit configured to generate, based on the error signal, a first control signal for controlling the focus position of the optical beam to a desired position;
a second control unit configured to generate, when driving of the optical head based on the error signal is not performed, a second control signal for controlling the focus position of the optical beam to a desired position;
a rotation synchronizing signal generation unit configured to generate a clock signal synchronized with a rotation of the optical disc;
a memory unit configured to sequentially store, as memory data, a control signal for controlling the focus position of the optical beam to a desired position in synchronization with the clock signal at an associated one of clock addresses whose one round is completed as the optical disc rotates once;
first and second memory data output units each being configured to sequentially read the memory data stored in the memory unit in synchronization with the clock signal;
a phase correction unit configured to correct, when each of the first and second memory data output units reads the memory data from the memory unit, a phase shift between a clock address for reading and a clock address for storing;
a control operation switch configured to receive the first and second control signals and selectively output one of the first control signal and the second control signal so that when the driving of the optical head based on the error signal is to be performed, the first control signal is output, and otherwise, the second control signal is output; and
an adding unit configured to add an output signal of each of the first and second memory data output units to an output signal of the control operation switch to generate the control signal,
wherein
the phase correction unit corrects the phase shift both when the driving of the optical head based on the error signal is performed and when the driving is not performed,
at least one of the first and second memory data output units is operated even when the driving of the optical head based on the error signal is not performed, and
when the driving of the optical head based on the error signal is not performed, input of the control signal to the memory unit is blocked, and connection of each of the first and second memory data output units with the adding unit is maintained to control the focus position of the optical beam using the control signal obtained by adding the memory data stored in the memory unit to the second control signal.

14. The focus position control apparatus of claim 13, wherein
the phase correction unit corrects the phase shift so that a frequency component in the error signal desired to be reduced is reduced.

15. The focus position control apparatus of claim 13, further comprising:
first and second filter units each being configured to extract a frequency component in a predetermined frequency band in an output signal of each of the first and second memory data output units,
wherein
the adding unit adds the output signal of each of the first and second memory data output units filtered by an associated one of the first and second filter units to the output signal of the control operation switch.

16. The focus position control apparatus of claim 15, wherein
at least one of the first and second filter units extracts a rotation frequency component of the optical disc in the output signal of each of the first and second memory data output units.

17. The focus position control apparatus of claim 13, wherein
when the driving of the optical head based on the error signal is not performed, the phase correction unit corrects the phase shift to a value with which a rotation frequency component of the optical disc in the error signal generated when the driving of the optical head has been performed is reduced.

18. The focus position control apparatus of claim 1, wherein
the error signal is at least one of a focus error signal indicating a shift of a focus of the optical beam from the recording surface and a tracking error signal indicating a shift of the focus of the optical beam from the track, and
the control signal is at least one of a focus control signal for adjusting the focus of the optical beam on the recording surface based on the focus error signal and a tracking control signal for causing the optical beam to follow the track based on the tracking error signal.

19. The focus position control apparatus of claim 8, wherein
the error signal is at least one of a focus error signal indicating a shift of a focus of the optical beam from the recording surface and a tracking error signal indicating a shift of the focus of the optical beam from the track, and
the control signal is at least one of a focus control signal for adjusting the focus of the optical beam on the recording surface based on the focus error signal and a tracking control signal for causing the optical beam to follow the track based on the tracking error signal.

20. The focus position control apparatus of claim 13, wherein
the error signal is at least one of a focus error signal indicating a shift of a focus of the optical beam from the recording surface and a tracking error signal indicating a shift of the focus of the optical beam from the track, and
the control signal is at least one of a focus control signal for adjusting the focus of the optical beam on the recording surface based on the focus error signal and a tracking control signal for causing the optical beam to follow the track based on the tracking error signal.

21. An optical disc apparatus, comprising:
the focus position control apparatus of claim 1;
an optical head configured to irradiate a recording surface of an optical disc with an optical beam, a focus position of the optical beam being controlled by the focus position control apparatus; and
a drive unit configured to drive the optical head.

22. An optical disc apparatus, comprising:
the focus position control apparatus of claim 8;
an optical head configured to irradiate a recording surface of an optical disc with an optical beam, a focus position of the optical beam being controlled by the focus position control apparatus; and
a drive unit configured to drive the optical head.

23. An optical disc apparatus, comprising:
the focus position control apparatus of claim 13;
an optical head configured to irradiate a recording surface of an optical disc with an optical beam, a focus position of the optical beam being controlled by the focus position control apparatus; and
a drive unit configured to drive the optical head.

24. A focus position control method for control of a focus position of an optical beam, the method comprising:
generating, based on an output signal from an optical head configured to irradiate an optical disc in which a track is formed on a recording surface with an optical beam to record or reproduce data, an error signal indicating an amount of a shift of a focus position of the optical beam from a desired position;
generating, based on the error signal, a first control signal for controlling the focus position of the optical beam to a desired position;
generating, when driving of the optical head based on the error signal is not performed, a second control signal for controlling the focus position of the optical beam to a desired position;
generating a clock signal synchronized with a rotation of the optical disc;
sequentially storing, as memory data, a control signal for controlling the focus position of the optical beam to a desired position in synchronization with the clock signal at an associated one of clock addresses whose one round is completed as the optical disc rotates once;
sequentially reading the stored memory data in synchronization with the clock signal;
correcting, when the stored memory data is read, a phase shift between a clock address for reading and a clock address for storing;
adding, when the driving of the optical head based on the error signal is to be performed, the read memory data to the first control signal to control the focus position of the optical beam based on a result of the adding; and
stopping, when the driving of the optical head based on the error signal is not performed, storing the control signal as the memory data and adding the read memory data to the second control signal to control the focus position of the optical beam based on a result of the adding.
